(19) United States
(12) Patent Application Publication
(10) Pub. No.: US 2026/0368607 A1
(43) Pub. Date: Nov. 19, 2026

(54) NOISY QUANTUM CHANNEL ERROR MITIGATION

(71) Applicant: NVIDIA Corporation, Santa Clara, CA (US)

(72) Inventors: Yuval Idan, Rision Le Zion (IL); Taylor Lee Patti, Orange, CA (US); Elad Mentovich, Tel Aviv (IL)

(21) Appl. No.: 19/295,997

(22) Filed: Aug. 11, 2025

Related U.S. Application Data
(60) Provisional application No. 63/771,789, filed on Mar. 14, 2025.

(51) Int. Cl. G06N 10/70

(52) U.S. Cl. CPC G06N 10/70

(57) ABSTRACT

Systems and methods for implementing noisy quantum channel error mitigation are described. For example, a system can receive input data indicative of an original quantum state of a quantum system that is modified by an amount of noise added by a non-unitary quantum channel, provide the input data to a machine learning model trained to predict the original quantum state in order to perform error mitigation by simulating an inverse of the non-unitary quantum channel, and obtain, from the machine learning model, output data indicative of the original quantum state.

### CROSS-REFERENCE TO RELATED APPLICATION(S)

The present application claims the benefit of U.S. Provisional Patent Application No. 63/771,789, filed on Mar. 14, 2025, the entire contents of which are hereby incorporated by reference herein.

### TECHNICAL FIELD

The present application generally relates to quantum computing, and more particularly to noisy quantum channel error mitigation (e.g., error correction).

### BACKGROUND

Quantum metrology and computing networks can leverage the laws of quantum mechanics, such as superposition, entanglement, and so on, to perform measurements of physical systems, process measurements of physical systems, and perform computations. In quantum computing, a quantum circuit can include hardware and/or software for quantum computation, in which a quantum computation is performed using a sequence of quantum (logic) gates, quantum measurements, etc.

### BRIEF DESCRIPTION OF THE DRAWINGS

FIG. 1 is a diagram illustrating an example system for implementing noisy quantum channel error mitigation, in accordance with at least one embodiment;

FIG. 2 is a diagram illustrating an example method of utilizing weak measurements to perform error mitigation on noisy quantum channels, in accordance with at least one embodiment;

FIG. 3 is a diagram illustrating an example machine learning model architecture that can be used to implement noisy quantum channel error mitigation, in accordance with at least one embodiment;

FIG. 4 is an example algorithm that can be used to implement a forward diffusion process that can be used to train a machine learning model to implement noisy quantum data error mitigation, in accordance with at least one embodiment;

FIG. 5 is a graph illustrating a relationship between average fidelity and the number of training examples, in accordance with at least one embodiment;

FIGS. 6A-6C are flowcharts illustrating example methods for training a machine learning model to implement noisy quantum channel error mitigation, in accordance with at least one embodiment;

FIG. 7 is a flowchart illustrating an example method for using a trained machine learning model to implement noisy quantum channel error mitigation, in accordance with at least one embodiment;

FIGS. 8A-8B illustrate a network architecture, in accordance with at least one embodiment;

FIG. 9 illustrates a distributed system, in accordance with at least one embodiment;

FIG. 10 illustrates an exemplary datacenter, in accordance with at least one embodiment;

FIG. 11 illustrates a client-server network, in accordance with at least one embodiment;

FIG. 12 illustrates a computer network, in accordance with at least one embodiment

FIG. 13A illustrates a networked computer system, in accordance with at least one embodiment;

FIG. 13B illustrates a networked computer system, in accordance with at least one embodiment; and

FIG. 13C illustrates a networked computer system, in accordance with at least one embodiment.

FIGS. 14A-14B depict an example data center architecture, in accordance with at least one embodiment.

### DETAILED DESCRIPTION

Embodiments described herein are related to implementing noisy quantum channel error mitigation (e.g., error correction) techniques. Quantum computers have entered the NISQ (Noisy Intermediate-Scale Quantum) era, characterized by quantum devices that operate with a limited number of quantum bits (qubits). Variational Quantum Algorithms (VQAs) have emerged as a leading paradigm for demonstrating quantum advantage on NISQ devices. VQAs operate within a hybrid quantum-classical framework, synergistically combining the strengths of both classical and quantum computational paradigms. The core structure of VQAs involves encoding classical data into a parameterized cost function, which is then evaluated using a quantum system, such as a quantum simulator or actual hardware. Subsequently, a classical optimizer is employed to iteratively refine the parameters of the quantum circuit, aiming to minimize the cost function. This iterative feedback loop between the quantum and classical components can enhance model accuracy and mitigate the impact of noise inherent in NISQ devices. Hybrid quantum-classical frameworks, such as VQAs, strategically combine the strengths of classical computing, such as its robustness for optimization, control, and error mitigation, with the unique computational power of quantum systems, particularly for specific subroutines that are intractable for classical methods. This pragmatic strategy acknowledges the current limitations of quantum hardware, such as noise and a limited number of qubits.

A quantum circuit can be designed such that the horizontal axis is time, conventionally from left to right, single horizontal lines are qubits double lines are classical bits, and objects connected by these lines define operations performed on the qubits (e.g., measurements or gates).

A quantum gate refers to a quantum circuit that operates on some number of qubits. Quantum gates are building blocks of quantum circuits, similar to classical logic gates for classical circuits.

Quantum gates are operators that can be represented by matrices corresponding to an orthonormal basis. For example, a quantum gate can be a unitary operator represented by a unitary matrix. Examples of quantum gates includes the identity gate, the Pauli gates (e.g., Pauli-X, Pauli-Y and Pauli-Z), the controlled gates, the Hadamard gate, the phase shift gates, the swap gate, the Toffoli gate, etc. A quantum circuit can be constructed based on a set of parameter values (e.g., a vector of parameter values), θ={θ₁, θ₂, . . . θₙ}, to create a wavefunction (e.g., |ψ(θ) [symbol] ). For example, the set of parameter values can include a set of rotation angles that define the rotation of a qubit around axes (e.g., X, Y and Z axes). More specifically, a set of parameter values can define parameters of quantum gates used to construct parameterized gates of the quantum circuit. For example, a wavefunction with n qubits can be represented by |ψ(θ) [symbol] =U(θ)|0 [symbol] ^{⊗n}, where |0 [symbol] represents the “0” state, U(θ) is a unitary operator representing the [symbol] quantum circuit or a sequence of quantum gates parameterized by θ, and the symbol ⊗ represents the tensor product. The other state can be the “1” state, represented by |1 [symbol] .

In classical information theory, a “classical channel” refers to a medium for transmitting classical information from a sender to a receiver. In quantum information theory, a “quantum channel” refers to a communication pathway capable of transmitting quantum information, which is inherently encoded in a quantum state of a quantum system (e.g., in a qubit). A quantum channel can describe the evolution of a quantum state within a quantum channel by a mapping from the quantum state to another quantum state. Conceptually, a quantum channel can be viewed as a pathway designed for the reliable transmission between locations. For example, a quantum channel can be used to transmit encoded information about a quantum state of a quantum system (e.g., via a qubit). More precisely, a quantum channel serves as a framework to describe how the quantum state of a system evolves over time, including the effects of noise and decoherence that pose challenges in practical quantum computing. The behavior and properties of a quantum channel can be dictated by quantum mechanical principles, such as the superposition of quantum states and quantum entanglement between multiple quantum systems. These quantum mechanical principles enable unique and powerful functionalities that are simply not achievable using classical communication channels or computational methods. Quantum channels can be used to enable quantum communication protocols. For example, a quantum channel may support quantum teleportation to enable the transmission of an arbitrary quantum state from one physical location to another, potentially across vast distances, without the need for the physical transfer of the particle or qubit that carries the state.

Broadly speaking, any discrete time change in the state of a quantum system that adheres to the fundamental principles of quantum mechanics can be fully described by a quantum channel. In particular, a quantum channel can be mathematically represented by a linear transformation of an input density matrix representing at least one quantum state of a quantum system, to an output density matrix representing the evolution of the at least one quantum state. For example, a quantum channel can be represented using a combination of linear operators in an operator-sum framework, also known as Kraus operators. The minimum number of Kraus operators used to represent a quantum channel is defined as its Kraus rank. A quantum channel that can be represented by only one Kraus operator (i.e., a quantum channel having a Kraus rank of 1) is referred to as a pure quantum channel. In this case, the evolution of the quantum state can be described by a single, deterministic operation, such as a unitary transformation, without any probabilistic mixing or noise. The operator-sum framework can be used to capture the complex effects of noise, energy dissipation, and other interactions that a quantum state might experience through a quantum channel. To maintain consistency with quantum mechanical principles, a quantum channel can be defined by a completely positive (CP) and trace-preserving (TP) linear map (CPTP linear map). The CP property means that the transformation not only maps any valid quantum state to another valid quantum state, but also ensures that this remains true even when the quantum system is considered as part of a larger system (e.g., a subsystem of a larger quantum entangled system). The TP property ensures that the total probability associated with any quantum state is conserved after the transformation (i.e., the probability remains exactly one). Accordingly, the CP property guarantees that the output of the channel is always a physically possible quantum state, while the TP property guarantees that no probability is lost or gained during the evolution of the quantum state through the quantum channel.

One example of a quantum channel is a unitary quantum channel, which reflects the application of a quantum gate to a quantum state. Mathematically, if the quantum state is represented by a density matrix ρ and the quantum gate by a unitary operator U, then the quantum state after passing through the unitary quantum channel is given by ρ′=UρU^{†}. This process is reversible and, in the absence of any interaction with the environment, represents noise-free evolution of the quantum state. Unitary quantum channels characterize the time evolution of closed quantum systems, where there is no exchange of energy or information with the surroundings, and serve as the idealized building blocks for quantum computations. For example, a perfect quantum channel that transmits any input quantum state without alteration can be represented by a unitary channel, where the unitary operator U is the identity operator (I), such that ρ′=IρI^{†}=ρ.

Quantum channels may be used as transmission media in quantum computing systems, such as to connect different quantum computing devices, different components of a quantum system, and so on. A quantum channel can transmit quantum information (such as qubits), as well as classical information, from one location to another.

Some quantum channels associated with quantum circuits of quantum computers can be noisy. For example, data transmitted via a quantum channel can experience dissipation or other types of noise, making the quantum channel a so-called “noisy” quantum channel. A noisy quantum channel is typically modeled as a non-unitary channel, meaning it does not preserve the original quantum state data (e.g., the density matrix) transmitted from a sender to a receiver. Instead, noise alters the quantum state during transmission, which can lead to errors. Noise refers to any interaction with the environment that causes the quantum state to deviate from its intended evolution. This includes factors such as decoherence (loss of quantum information), imperfect control of quantum gates, or interactions with other quantum systems. Noise in the quantum channel can arise from various sources, including imperfect control operations, environmental interactions, and hardware limitations, all of which can significantly degrade the accuracy of quantum computations. For instance, noise can introduce errors in the measurement of observables (such as energy levels) of a quantum system, as determined by a quantum circuit executed on a quantum computer. Even minor environmental disturbances-such as stray magnetic or electric fields, thermal fluctuations, or unintended interactions with other particles or qubits—can significantly perturb the quantum state.

When noise is present, it can cause information loss, incorrect manipulation of qubits during quantum logic operations (such as unintended rotations or faulty gate applications), and other operational errors. The likelihood and severity of these errors can increase as the size and complexity of the quantum computer grows, due to the greater number of qubits and operations involved. For example, noise can gradually degrade or erase the quantum information (e.g., encoded in the qubits), leading to a loss of quantum state coherence and fidelity. This corruption of quantum data can result in the accumulation of errors in quantum computations and communications. Over time, these accumulated errors can cause the transmitted quantum state to completely deviate from the original state (e.g., through decoherence). This presents a significant challenge for achieving reliable quantum computation and highlights the need for effective error mitigation (e.g., error correction) techniques to address errors caused by transmission through noisy quantum channels.

Embodiments described herein can address these and other drawbacks by implementing noisy quantum channel error mitigation by training a machine learning model to map noisy quantum state information to an original, noise-free quantum state. Embodiments described herein are also related to the transfer of optical qubits over long distances, cleaning a quantum state before it goes to the next quantum computing system.

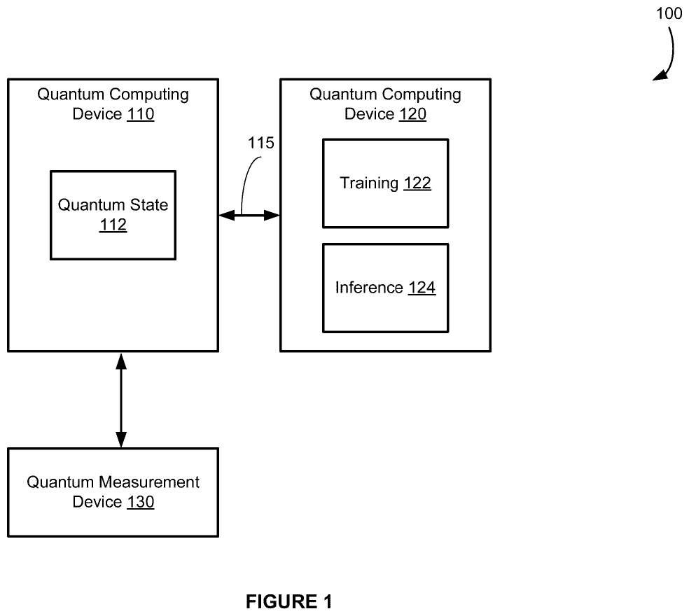

The present technique can utilize weak measurements (e.g. mid-circuit weak measurements) to simulate a noisy quantum channel, and thus generate training data for training a machine learning model to perform noisy quantum channel error mitigation. A “weak” measurement refers to a measurement that only slightly disturbs a quantum system, as opposed to a “strong” measurement that completely disturbs the quantum system (e.g., collapses a wave function). The weak measurements may be used to create any type of noisy quantum channel. This can be achieved by performing many weak measurements to create artificial noisy quantum channels. The measurement strength can be tuned, allowing for the measurement of any type of property and the creation of any type of noisy channel. The trained machine learning model can then be used to perform error mitigation. A machine learning model described herein can be trained to recover an original quantum state by removing noise introduced by a noisy quantum channel, and thus approximate an inverse quantum channel. The machine learning model described herein can be used to identify at least one noise type added by at least one non-unitary quantum channel. In at least one embodiment, a machine learning model is a diffusion model. Further details regarding implementing noisy quantum channel error mitigation will be described below with reference to FIGS. 1-13C.

The trained machine learning model can be deployed in real quantum computing systems or experimental setups to perform error mitigation protocols (e.g., in situ cutting-edge error mitigation protocol) providing more accurate and reliable data for training the model. In at least one embodiment, the training process utilizes both simulated and non-simulated (experimental) data, allowing the machine learning model to learn from real-world noise characteristics and operational imperfections. This approach can result in more robust and effective error mitigation protocols that are better suited to practical quantum computing environments.

Embodiments described herein can be used in various quantum computing applications. Examples of quantum computing applications include error mitigation, secure quantum communication, quantum teleportation, etc. For example, embodiments described herein can be used to protect quantum information from error caused by various types of noise introduced by non-unitary quantum channels, such as depolarizing noise, amplitude damping noise, and phase damping noise, among others.

Systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., raytracing, path tracing, etc.), collaborative content creation for 3D assets, generative AI operations using (e.g., large) language models, cloud computing and/or any other suitable applications. The systems and methods described herein may be used in a system for compiling a quantum circuit, a system for executing a quantum circuit, a system for measuring a quantum state, and/or a system for measuring a state of a qubit or qubits.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using (large) language models, systems for performing light transport simulation, systems for performing collaborative content creation for 3D assets, systems implemented at least partially using cloud computing resources, and/or other types of systems.

In the following and preceding description, numerous specific details are set forth to provide a more thorough understanding of at least one embodiment. However, it will be apparent to one skilled in the art that the inventive concepts may be practiced without one or more of these specific details. Following figures set forth, without limitation, example systems and methods that implement collective communication protocols for quantum metrology.

FIG. 1 is a block diagram illustrating a system 100 for implementing noisy quantum channel error mitigation, in accordance with at least one embodiment. As shown in FIG. 1, the system 100 can include a quantum computing device 110 communicably coupled via a quantum channel 115 to a quantum computing device 120. In at least one embodiment, the quantum channel 115 corresponds to an interconnect. For example, an interconnect can enable communication between one or more processing units of the quantum computing device 110 and one or more processing units of the quantum computing device 120.

The quantum computing device 110 can transmit a quantum state 112 of a quantum system to the quantum computing device 120 via the quantum channel 115. More specifically, the quantum state 112 can represent an original quantum state of the quantum system. In at least one embodiment, the quantum channel 115 is a noisy quantum channel that introduces noise into the quantum state 112. More specifically, a noisy quantum channel can be any suitable non-unitary quantum channel in accordance with embodiments described herein. One example of a non-unitary quantum channel is a depolarizing channel. A depolarizing channel can be used to model depolarizing noise. For example, a unit of quantum information (such as a qubit) retains its quantum state with probability p, and with probability 1-p, it loses all quantum information. In the latter case, the quantum state 112 is transformed into a maximally mixed state, represented by the identity operator I divided by the dimension of the Hilbert space associated with the quantum system (for example, I/2 for a qubit).

Another example of a non-unitary quantum channel is an amplitude damping channel. An amplitude damping channel can be used to model the process by which a unit of quantum information (e.g., a qubit) loses energy to its environment with a certain amplitude damping probability, potentially causing a transition from the excited state to the ground state.

Another example of a non-unitary quantum channel is a phase damping channel. A phase damping channel can be used to model the loss of quantum information due to random phase fluctuations, without any exchange of energy with the environment.

Another example of a non-unitary quantum channel is a bit-flip channel. A bit-flip channel can be used to flip the state of a qubit from |0 [symbol] to |1 [symbol] or vice versa with a certain probability p.

In at least one embodiment, and as shown FIG. 1, the quantum computing device 120 includes an error mitigation system. In other embodiments, at least one component of the error mitigation system is located in a separate computing system.

The error mitigation system can perform noisy quantum channel error mitigation. In particular, noisy quantum channel error mitigation as described herein can be achieved by training a machine learning model to map noisy quantum information to its corresponding ideal (noise-free) quantum state.

For example, the error mitigation system can include a training component 122. The training component 122 can train a machine learning model during a training stage to approximate the inverse of a noisy quantum channel that removes noise introduced by a noisy quantum channel. In at least one embodiment, the training process utilizes both simulated and non-simulated (experimental) data, allowing the machine learning model to learn from real-world noise characteristics and operational imperfections. This approach can result in more robust and effective error mitigation protocols that are better suited to practical quantum computing environments. The trained machine learning model can be deployed in real quantum computing systems, hybrid computing systems that include both quantum computing components and traditional computing components, and/or experimental setups to perform error mitigation protocols in situ. Additionally or alternatively, the error mitigation system can include an inference component 124. The inference component 124 can, during an inference stage, use a trained machine learning model to recover the quantum state 112. Accordingly, the quantum computing device 120 can receive, via the quantum channel 115, input data indicative of an quantum state 112 (sent by the quantum computing device 110) that is modified by an amount of noise added by the quantum channel 115, provide the input data to a machine learning model trained by the training component 122 to predict the quantum state 112 by simulating an inverse of the quantum channel 115, and obtain, from the machine learning model via the inference component 124, output data indicative of the quantum state 112.

In at least one embodiment, the machine learning model is a generative model trained to predict and reconstruct an original quantum state (e.g., the quantum state 112) from input data, thereby generating the original quantum state as an output. For example, the machine learning model can be a diffusion model, which is a class of generative models designed to iteratively denoise input data. In general, a diffusion model is trained to generate output data by learning to remove noise that has been systematically added to the input data. This makes diffusion models particularly suitable for recovering corrupted or noisy data, such as quantum state data impacted by noise due to transmission through a noisy quantum channel.

If the machine learning model is a diffusion model, training the machine learning model during the training stage using the training component 122 typically involves two main processes: a forward diffusion process and a reverse diffusion process. In the forward diffusion process, random noise is progressively added to the data over a series of discrete time steps, such that the data transitions from its original form to a state of nearly pure noise. Each step in the forward diffusion process depends on the previous step. For example, the forward diffusion process can be mathematically modeled as a Markov chain, where the probability distribution of the data at each step depends only on the immediately preceding step. The reverse diffusion process is then learned by the diffusion model during training. In this process, the model is trained to reverse the effects of the forward diffusion process, step by step, by predicting and removing the noise that was added at each step. The objective of the reverse diffusion process is for the model to reconstruct noise-free data from the noisy input. Using a trained machine learning model during the inference stage using the inference component 124 can include receiving input data that represents a noisy or corrupted quantum state (or even pure random noise), and iteratively applying the learned reverse diffusion process to generate output data that approximates the original (denoised) quantum state. Thus, the output quantum state data produced by the trained diffusion model corresponds to a predicted, noise-corrected version of the input quantum state data, enabling a practical implementation of effective quantum data error mitigation.

In at least one embodiment, a machine learning model (e.g., a diffusion model) is implemented using a recurrent neural network (RNN)-based architecture. RNNs are neural networks designed to process sequential data by maintaining internal hidden states that capture information from previous time steps. This makes them well-suited for tasks involving temporal or sequential dependencies, such as time series prediction, speech recognition, and video analysis. In the context of quantum systems, RNNs can be particularly advantageous when modeling noisy quantum channels that can be represented as a sequence of weak measurements, where each measurement provides partial information about the quantum state.

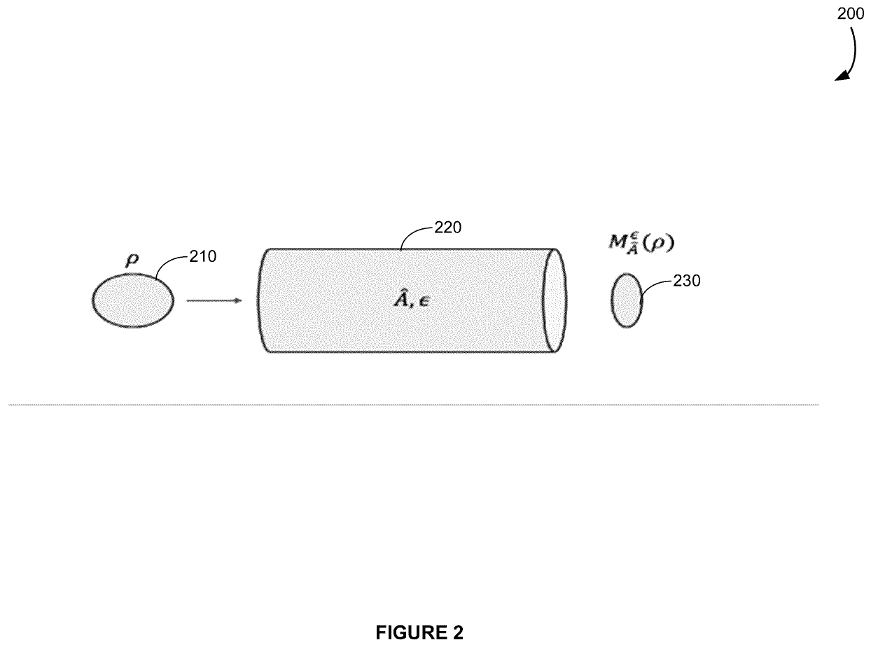

One type of RNN that can be used is the long short-term memory network (LSTM). LSTMs are designed to capture both short-term and long-term dependencies in sequential data through a system of gates, referred to as input, forget, and output gates, and a cell state that acts as a memory. These gates regulate the flow of information, allowing the network to selectively retain or discard information over time. An LSTM can be structured with main layers and hidden layers: the main layers are responsible for capturing long-term correlations (e.g., relationships between initial quantum states across sequences), while the hidden layers capture short-term correlations (e.g., changes between consecutive time steps or measurements). In this framework, the short-term correlations modeled by the hidden layers can be used to represent the dissipation or evolution of quantum states over a sequence of weak measurements. The long-term correlations captured by the main layers can be used to relate these sequences to a reference scenario, such as the evolution of a quantum state toward the maximally mixed state (i.e., the state in which the quantum system is in a completely random mixture of all possible basis states). The maximally mixed state has maximum entropy and no information about the initial quantum state is retained. This dual-level modeling enables the LSTM to learn both the immediate effects of individual weak measurements and the overall trajectory of the quantum state, providing a comprehensive approach to reconstructing or denoising quantum states from weak measurement data. An example RNN (e.g., LSTM) that can be used to implement a machine learning model for noisy quantum channel error mitigation is described below with reference to FIG. 2.

One technical challenge in the error mitigation system implementing noisy quantum channel error mitigation using a machine learning model (such as a diffusion model) is the potential lack of sufficient and representative training data required for effective training. To address this issue, the error mitigation system can use a process to generate synthetic training data specifically tailored for training a machine learning model to perform noisy quantum channel error mitigation. This process can involve generating multiple random pure quantum states, for example, by applying random unitary matrices to a fixed reference state (such as the ground state). Each generated pure state can then be transmitted through a randomly selected quantum channel, which may be characterized by a specific type of quantum channel (e.g., depolarizing, amplitude damping, or phase damping channel). The output, or the resulting noisy quantum state after transmission, is recorded along with the corresponding original pure state. This pair of data—including the noisy output and the known original input—serves as a training example. By repeating this process for a sufficiently large number of random pure states and random quantum channels, a comprehensive training dataset can be constructed. This dataset can then be used to train a machine learning model, such as a diffusion model, to learn the mapping from a noisy quantum state to a corresponding denoised quantum state, thereby enabling the model to perform effective quantum data error mitigation.

In at least one embodiment, generating training data includes performing “weak” measurements on the quantum computing device 110 using a quantum measurement device 130. A weak measurement is a type of quantum measurement that only minimally disturbs the quantum state 112, such as by only partially collapsing the wave function. This is in contrast to a “strong” measurement, which is a type of quantum measurement that fully collapses the wave function and completely disturbs the quantum state 112. In a weak measurement, the quantum state 112 is only partially projected onto the quantum measurement device 130, meaning that the measurement outcome provides limited information about a measured observable. As a result, the quantum state 112 after a weak measurement can become partially noisy, with the degree of noise depending on the specific observable being measured and the strength of the measurement interaction. the properties being measured can include magnetic fields in different bases (X, Y, Z). The noise induced depends on the basis being measured. The effect of the measurement on the quantum state depends on the state itself. For example, measuring spin Z on a spin Z state induces no noise, while measuring spin Z on a spin X state deletes information. Additionally, weak measurements can yield so-called “anomalous values,” which are measurement outcomes that may fall outside the expected range of eigenvalues for the measured observable. Additionally, by generating multiple weak measurements in sequence, a quantum state may deviate further and further from an original state in an observable manner.

Due to these properties of weak measurements, they can be used as training data that simulates the effects of a noisy quantum channel by introducing controlled, incremental noise into the quantum computing device 110, while still preserving at least some information about the quantum state 112. In particular, the training component 122 can train a machine learning model (e.g., a diffusion model) to perform error mitigation for noisy quantum channels by removing noise from data generated by one or more weak measurements. Since a single weak measurement typically provides limited information about the quantum state 112, multiple weak measurements-possibly performed on a single quantum system or identically prepared quantum systems including the quantum computing device 110—can be combined (e.g., through statistical averaging or data fusion techniques) to extract more accurate and meaningful information about the quantum state 112. Furthermore, weak measurements can be used in conjunction with pre-selection (preparing the quantum system in a known initial state) and post-selection (selecting a specific final state after the weak measurement). The inference component 124 can use such a trained machine learning model to remove noise from data resulting from one or more weak measurements of a quantum system modeling noise. For example, a single weak measurement, or a sequence of weak measurements, can be provided as input to the trained machine learning model, which then predicts the quantum state 112 from the input and reconstructs the quantum state 112 as output.

As an illustrative example of training by the training component 122, a machine learning model described herein (e.g., an LSTM model) can be trained, using appropriate training data, to predict the backward evolution of each density matrix that has been used to simulate a noisy quantum channel. By predicting the backward evolution of each density matrix, the machine learning model can identify the corresponding inverse quantum channel that effectively removes the noise introduced by the noisy quantum channel. During an initial stage of this training, the machine learning model can be exposed to an unknown quantum channel constructed using a set of random elements, such as random Positive-Operator Valued Measure (POVM) elements, which are applied as weak projections on a randomly chosen quantum state. This initial quantum state is designated as a prime example. A control system can repeatedly apply these measurements with constant interaction strength to the prime example, driving its evolution until the quantum state approaches the maximally mixed state. Once the maximally mixed state is reached or closely approximated, the control system can halt the measurements and record the entire sequence of density matrices representing the state's evolution, assuming the density matrices have been reconstructed at each step (e.g., by performing quantum state tomography or other suitable technique). Following this initial stage, additional pure quantum states, which can be correlated with the prime example via unitary rotations, can be input into the same unknown quantum channel. The evolution of their respective density matrices can be monitored and recorded in a similar manner. Unlike the prime example, these additional quantum states may not necessarily reach the maximally mixed state, as their final states depend on both the interaction strength and the number of measurements applied. The machine learning model can be trained to analyze the evolution of these various examples, enable it to learn the characteristics and structure of the underlying quantum channel. As an illustrative example of inference by the inference component 124, a trained machine learning model can be used to identify an inverse quantum channel that can transform the maximally mixed state of the prime example back into its original pure state. This approach enables the reconstruction or denoising of noisy quantum states. In at least one embodiment, at least two quantum channels are sequentially combined to form a composite quantum channel. This framework can be further generalized to high-dimensional Hilbert spaces, allowing the machine learning model to handle quantum systems with larger state spaces and more complex noise processes. Further details regarding implementing noisy channel error mitigation, including training machine learning models to implement noisy channel error mitigation, will now be described below with reference to FIGS. 2-7.

FIG. 2 is a diagram 200 illustrating a method of utilizing weak measurements to perform error mitigation on noisy quantum channels, according to at least one embodiment. As shown, a quantum state 210, represented by the density matrix “ρ”, enters a weak measurement channel 220 associated with a basis designated by “Â” and a measurement strength designated by “ε”. The weak measurement channel 220 can generate a measurement 230 of the quantum state 210 onto the basis of Â observable with measurement strength ε, represented by

$$M \frac{ε}{\hat{A}} ( ρ ) .$$

The following is a formal mathematical description of weak measurements that can be used as training data for training a machine learning model for noisy quantum channel error mitigation, and machine learning models (e.g., diffusion models) used to implement noisy quantum channel error mitigation.

For an arbitrary two state quantum system |ψ [symbol] =Σᵢaᵢ|i [symbol] , a weak measurement of |ψ [symbol] can be made with respect to an observable Â. The quantum system represented by quantum state |ψ [symbol] can be weakly coupled to an auxiliary quantum system referred to as the “pointer state” or “pointer.” The pointer is typically modeled as a continuous variable quantum system, represented by the quantum state |φ [symbol] =∫ψₓ|x [symbol] dx, where ∫|ψₓ|² dx=1. The interaction between the quantum system |ψ [symbol] and the pointer |φ [symbol] can be governed by the von Neumann projection measurement scheme, which applies a unitary operator to the joint state based on |ψ [symbol] and |φ [symbol] .

For example, a Von Neumann projection measurement can be performed as follows:

e^{-γÂ⊗\hat{P}}|ψ [symbol] |φ(x) [symbol] =|ψ [symbol] φ(x−γαᵢ) [symbol] (1)

where γ is a small coupling parameter corresponding to an interaction strength (γ<<1) and \hat{P} is a momentum operator. This interaction causes the pointer to shift in accordance with the eigenvalues of Â and the coupling parameter γ. After the interaction, tracing out the pointer degrees of freedom defines a monitoring transformation [symbol] (ρ), which can describe the evolution of the initial quantum state represented by the density matrix ρ=|ψ [symbol] ψ| under the influence of the weak measurement as follows:

[symbol]

(φ=(1−ε)ρ+εΦ_{Â}(ρ) (2)

where ε is a measurement strength parameter, which quantifies how strongly the measurement disturbs the system (with ε=0 corresponding to no measurement and ε=1 corresponding to a fully projective measurement). Φ_{Â}(ρ) represents a specific type of noise, error or operation that acts on p (e.g., depolarizing, dephasing, bit-flip, phase-flip, amplitude damping, etc.). The monitoring transformation described by equation (2) decomposes the initial pre-measured density matrix into two components: an original (unmeasured) quantum state component and a projected quantum state component. The projected quantum state component corresponds to the quantum state after it has been projected onto the eigenbasis of the measured observable, representing the outcome of a projective measurement. Thus, the measurement strength parameter E determines the relative weights of each component. In at least one embodiment, sequential weak measurements are performed to generate simulated training data. More specifically, multiple weak projections can be applied in succession. Collectively, these multiple weak projections can approximate the effect of a single strong (projective) measurement, but with each step only partially collapsing the quantum state. This approach allows for the extraction of partial or approximate information about several observables simultaneously, especially when the observables do not commute. However, it is important to note that weaker measurements yield less precise information about the observable, and the results are more susceptible to statistical fluctuations. Furthermore, performing sequential weak measurements on non-commuting observables can be more disruptive to the quantum state than a single projective measurement, as each measurement can partially erase information gained from previous measurements. When sequential weak measurements are performed on the same observable with the same measurement strength parameter c, the cumulative effect can be described by a series of n monitoring transformations. This can lead to a gradual evolution of the quantum state p as described by the following equation:

[M(ρ)]ⁿ=(1−ϵ)ⁿρ+(1−(1−ϵ)ⁿ)Φ_{Â}(ρ) (3)

It can be seen that the quantum state p can be gradually transformed into the projected component on the observable basis. Performing sequential weak measurements on many different observables Oᵢ ∈{A, B, C, D . . . } yields a transformation represented by the following nested sum equation:

ρ^{out}=(1−ϵ)ⁿρ+Σᵢ(ϵ(1−ϵ)ⁿ⁻¹Φ(ρ)^{I}^{ᵢ}+Σⱼ(ϵ²(1−ϵ)ⁿ⁻²Φ(ρ)^{O}^{ᵢ}^{O}^{ⱼ}+Σₖ(ϵ³(1−ϵ)ⁿ⁻³Φ(ρ)^{O}^{ᵢ}^{O}^{ⱼ}^{O}^{ₖ}+ . . . +Σ_{z}(ϵⁿΦ(ρ)^{O}^{ᵢ}^{. . . O}^{_{z}})))) (4)

Thus, the evolution of the quantum state can depend on the measurement strength parameter ϵ. In certain scenarios, this dependence can lead to an equal decomposition of the density matrix ρ across all measured observables, effectively distributing the quantum information. When a sequence of weak measurements is performed, the quantum state undergoes a gradual evolution, taking incremental steps towards the maximally mixed state (i.e., a complete loss of information about the original quantum state). This process is a result of the cumulative decoherence introduced by the sequential weak measurements. However, if the quantum state is weakly projected onto a large set of non-commuting observables, the system can resist full decoherence, making it nearly impossible to reach the maximally mixed state. This is because the information about the initial quantum state is distributed among incompatible measurement bases, and no single measurement can fully erase it. In such cases, Two-State Vector Formalism (TSVF), which often relies on post-selection of the density matrix p, may not be applicable for describing the system's evolution. Instead, the quantum state can naturally approach the maximally mixed state through the dissipative effects of weak measurements, a process that can be further facilitated by coupling to auxiliary systems or environments. In some instances, machine learning techniques such as Generative Adversarial Networks (GANs) can be employed to assist in denoising quantum states by learning to distinguish and correct noise-induced errors, thereby improving the fidelity of quantum information processing in the presence of weak measurement-induced decoherence.

The following provides a more detailed description of implementing machine learning models, and specifically diffusion models in at least one embodiment, that can be utilized for error mitigation in noisy quantum channels. As described above, a diffusion model can be trained by employing a forward diffusion process, which incrementally adds noise to the original (“denoised” or “clean”) quantum state data across multiple steps, ultimately resulting in “fully-noised” quantum state data (i.e., the quantum state after the final noise-addition step). For example, the original quantum state data can be representative of a pure quantum state. The diffusion model can then learn a reverse diffusion process, which aims to reconstruct the original quantum state data from the fully-noised data by sequentially removing the noise in a stepwise manner. This approach enables the diffusion model to approximate the inverse of the noise added by the forward diffusion process, thereby facilitating the recovery of the original quantum state. The forward and reverse diffusion processes can be parameterized as Markov chains, and the diffusion model can be trained to minimize the discrepancy between the reconstructed and original quantum states, often using loss functions such as mean squared error or quantum fidelity metrics.

For example, the forward diffusion process for a data distribution q(x⁽⁰⁾) can be written as:

$$q ( {x}^{( 0 … T )} ) = q ( {x}^{( 0 )} ) {\prod }_{t = 1}^{T} q ( {x}^{( t )} \vert {x}^{( t - 1 )} ) \qquad ( 5 )$$

In equation (5), x^{(t)} represents the quantum state data after t steps of adding noise during the forward diffusion process (e.g., x⁽⁰⁾ is the original quantum state data and x^{(T)} is the fully-noised quantum state data), q(x⁽⁰⁾) represents the probability distribution of the original quantum state data, q(x^{(t)}) represents the probability distribution of the quantum state data at step t of the forward diffusion process, and q(x^{(0 . . . T)}) represents the joint probability distribution of the entire diffusion trajectory from x⁽⁰⁾ to x^{(T)} (i.e., the probability of observing this particular sequence of noisy quantum states from start to finish). The term q(x^{(t)}|x^{(t-1)}) represents the conditional probability of the quantum state data at step t given x^{(t-1)} (i.e., the probability of transitioning from one noisy quantum state to the next noisy quantum state). In at least one embodiment, q(x^{(t)}|x^{(t-1)})=T_{π}(x^{(t)}|x^{(t-1)}; βₜ), where T_{π} is the Markov kernel and βₜ is the diffusion rate controlling the amount of noise added at each step. Accordingly, equation (5) essentially states that the joint probability of the entire diffusion trajectory can be expressed as the probability of the original (denoised) quantum state data multiplied by the product of the conditional probabilities of transitioning from one noisy quantum state to the next.

The reverse diffusion process can be written as:

$$p ( {x}^{( 0 )} ) = p ( {x}^{( T )} ) {\prod }_{t = 1}^{T} p ( {x}^{( t - 1 )} \vert {x}^{( t )} ) \qquad ( 6 )$$

In equation (6), p(x^{(t)}) represents the probability distribution of quantum state data at step t of the forward diffusion process, p(x⁽⁰⁾) represents the probability distribution of the original quantum state data, and p(x^{(T)}) represents the probability distribution of the fully-noised quantum state data). The term p(x^{(t-1)}|x^{(t)}) represents the conditional probability of the data at step t-1 given x^{(t)} (i.e., the probability of denoising the quantum state data by one step). Therefore, equation (6) essentially states that states that the probability of the original quantum state data can be expressed as the probability of the fully-noised quantum state data multiplied by the product of the conditional probabilities of reversing each noise step. Accordingly, equation (6) can govern the process of training the diffusion model to implement a reverse diffusion process to generate, based on an arbitrary noisy quantum state, a prediction of an original quantum state.

A noisy quantum channel, acting on an input quantum state represented by a density matrix ρ, can be represented by [symbol] (ρ), such that ρ= [symbol] ⁻¹( [symbol] (ρ)) where [symbol] ⁻¹(·) represents the inverse quantum channel. The inverse quantum channel is not necessarily a physical quantum channel. As an illustrative example, a noisy quantum channel can be implemented as a depolarizing channel. However, other types of noisy quantum channels are contemplated, which can have more complicated inverse quantum channels. A depolarizing channel model can be used to represent a type of noise in quantum systems where information is lost by projecting the state onto a statistical mixture of all possible states. A depolarizing channel can be modeled by

$${D}_{p} ( ρ ) = p ρ + ( 1 - p ) \frac{T r ( ρ )}{{2}^{n}} \text{?} ,$$

where Dₚ(ρ) represents the output quantum state after it has passed through the depolarizing channel. The term

$$\frac{T r ( ρ )}{{2}^{n}} \text{?}$$

represents the maximally mixed state within an associated Hilbert space, where Tr(ρ) is the trace of the density matrix representing the quantum state (e.g., Tr(ρ)=1 for a valid quantum state), n is the number of qubits defining the dimensionality of the Hilbert space, and 1 is the identity matrix within the Hilbert space (e.g.,

$$( \begin{matrix}1 & 0 \\ 0 & 1\end{matrix} )$$

in a single qubit implementation). Thus, in a single qubit implementation, the maximally mixed state for a valid quantum state can be represented by

$$\frac{1}{2} ( \begin{matrix}1 & 0 \\ 0 & 1\end{matrix} ) .$$

The parameter p represents the probability that the quantum state represented by ρ passes through the depolarizing channel undisturbed and (1-p) represents the probability the quantum state is depolarized by the depolarizing channel. For example, if p=1 then the depolarizing channel is ideal and D₁(ρ)=ρ. As another example, if p=0, then the depolarizing channel maximally depolarizes the quantum state, thereby turning the quantum state into a maximally mixed state. It can be deduced that the inverse depolarizing channel can be modeled by

$${D}_{p}^{- 1} ( ρ ) = \frac{1}{p} ρ - ( 1 - \frac{1}{p} ) \frac{T r ( ρ )}{{2}^{n}} \text{?} .$$

In at least one embodiment, a quantum channel (and similarly an inverse quantum channel) can be represented by a global channel defined as a product of local channels. For example,

$$ℳ ( ρ ) = {⊗}_{i = 1}^{N} {ℳ}_{i} ( {ρ}_{i} ) ,$$

where [symbol] ᵢ(ρᵢ) is an i-th local quantum channel corresponding to an i-th local quantum state ρᵢ, and

$$ρ = {⊗}_{i = 1}^{N} {ρ}_{i} .$$

The quantum channel can act on the quantum state T times as described above, which can be represented by:

$${ℳ}^{( 0 … T )} ( ρ ) = {\prod }_{t = 1}^{T} ( {⊗}_{i = 1}^{N} {ℳ}_{i} ( {ρ}_{i}^{t} ) ) = {\prod }_{t = 1}^{T} ( ℳ ( {ρ}^{t} ) ) \qquad ( 7 )$$

and the inverse quantum channel can be represented by:

$${( {ℳ}^{( 0 … T )} )}^{- 1} ( ρ ) = {\prod }_{t = 1}^{T} ( {⊗}_{i = 1}^{N} {ℳ}_{i}^{- 1} ( {ρ}_{i}^{t} ) ) = {\prod }_{t = 1}^{T} ( {ℳ}^{- 1} ( {ρ}^{t} ) ) \qquad ( 8 )$$

The product of small inverse quantum channels can act as an error mitigation protocol to remove the noise from a noisy quantum channel. It can also help with identifying more trivial and compact structures in quantum computer algorithms. For example, it may be possible to denoise a single qubit quantum state on a quantum circuit algorithm that acts on an arbitrary state [symbol] |ψ [symbol] →UρU^{†}, where [symbol] |ψ [symbol] corresponds to the time-evolved pure quantum state at time t starting from an initial pure state |ψ [symbol] and Hamiltonian [symbol] , U is an operator representing a reversible quantum operation or evolution, and U^{†} is the Hermitian conjugate of U (e.g., if U is a unitary operator, then U^{†}=U⁻¹). The Hamiltonian [symbol] for the entire system (including the pointers) can be separated into n steps using a Trotter approximation [symbol] ≈(Πₖ [symbol] )ⁿ, where [symbol] =Σₖ [symbol] ₖ. Using the Trotter approximation can enable noise to be cleaned from a gate-dependent quantum algorithm, and can enable noise to be used with auxiliary quantum data (e.g., qubits) to generate a quantum algorithm.

As described above, the goal of noisy quantum channel error mitigation described herein is to determine a suitable inverse quantum channel that can transition from an approximately maximally mixed state towards a pure quantum state. As also described above, an LSTM is one type of architecture that can be used to implement a machine learning model (e.g., diffusion model) to determine the inverse quantum channel given the ability of the LSTM to effective handle time sequence data. The short-term correlations of the LSTM can be calculated from each time step t that is an iteration with unknown monitoring channel [symbol] (ρ) which transforms density matrix ρ^{(t)}→ρ^{(t+1)}. The LSTM input will be ρ^{(T)}, where ρ^{(T)} represents the fully-noised quantum state at the final time step T (up to some predetermined threshold), and the LSTM output is the approximated inverse sequence from ρ^{(T)} to ρ⁽⁰⁾, where ρ⁽⁰⁾ represents original, denoised quantum state. Thus, the LSTM can remove noise that was induced on ρ. The LSTM also has the capability to transform one density matrix into other via the following sequence:

$${ρ}_{1}^{0} , … , {ρ}_{1}^{T} , {ρ}_{0}^{T} , … , {ρ}_{2}^{T} .$$

The LSTM can transform a pure quantum state into a mixed state (e.g., a maximally mixed state). The evolution of a first quantum state represented by a first density matrix ρ₀ under a first sequence of weak measurements simulating a noisy quantum channel can be represented as

$$( {ρ}_{0}^{( 0 )} , {ρ}_{0}^{( 1 )} , … {ρ}_{0}^{( T - 1 )} , {ρ}_{0}^{( T )} ) .$$

### Here,

$${ρ}_{0}^{( 0 )}$$

represents a first random pure quantum state and

$${ρ}_{0}^{( T )}$$

represents the maximally mixed state (e.g., interpreted as white noise).

$${ρ}_{0}^{( T )}$$

can be approximately equal to

$$\frac{\text{?}}{d} ,$$

where d is the dimension of the Hilbert space (e.g., 2 for a single qubit).

$${ρ}_{0}^{( T )}$$

is the initial quantum state for the noisy quantum channel, meaning that the noisy quantum channel is designed to operate in accordance with this transformation. The set of weak measurements may be unknown, but they act as a noisy quantum channel, and in average if ϵ<<1, then the average noisy quantum channel can act as a depolarized quantum channel. After the evolution of the first quantum state

$${ρ}_{0}^{( 0 )} ,$$

the noisy quantum channel's input state can be changed to a second random pure quantum state

$${ρ}_{1}^{( 0 )} ,$$

For example,

$${ρ}_{1}^{( 0 )}$$

can be a rotation of

$${ρ}_{0}^{( 0 )} ( e . g . , {ρ}_{1}^{( 0 )} = {e}^{- iℋt} {ρ}_{0}^{( 0 )} {e}^{iℋt ) .}$$

Thus, the evolution of the second quantum state represented by the second density matrix ρ₁ under a second sequence of weak measurements simulating the noisy quantum channel can be represented as

$$( {ρ}_{1}^{( 0 )} , {ρ}_{1}^{( 1 )} , … {ρ}_{1}^{( T - 1 )} , {ρ}_{1}^{( T )} ) .$$

A training dataset D used to train the machine learning model can include n examples. For example,

$$D = \{ {ρ}_{i}^{( j )} \vert i ∈ \{ 0 , … n \} , j ∈ \{ 0 , … T \} \} .$$

In at least one embodiment, the input features of the machine learning model are defined as follows: [N, S, 2, D, 2, 2], where N is number of examples (batch size), Sis the sequence length, 2 defines real and imaginary, D is the number of qubits, and 2, 2 defines a 2×2 size of the density matrix representing the quantum state. The data loader class convert the input features into converted features [N, S, 8D], and then pass the converted features through the machine learning model. For each sequence, the machine learning model can predict an output corresponding to the original quantum state and/or the inverse quantum channel that transforms the final fully-noised quantum state back to the original quantum state. The output can be determined via the machine learning model weights.

Assume a simple single qubit case, where D=1. The state space of a single qubit can be geometrically represented by a Bloch sphere, which is a unit sphere. In particular, each pure state of the qubit can be mapped to a point on the surface of the Bloch sphere, while each mixed state of the qubit can be represented by any point inside Block sphere (i.e., not on the surface). For a single qubit, a density matrix representing the state of the qubit can be written as

$$ρ = \frac{1}{2} ( I + \vec{r} \cdot \vec{σ} ) = \frac{1}{2} ( I + {r}_{x} {σ}_{x} + {r}_{y} {σ}_{y} + {r}_{z} {σ}_{z} ) ,$$

where \vec{r} is a the Bloch vector (i.e., ∥\vec{r}∥₂=1 for a pure state and ∥\vec{r}∥₂<1 for a mixed state) and \vec{σ} represent Pauli matrices. Pauli matrices are Hermitian and unitary matrices that represent operators that can be used to describe spin-1/2 particles such as qubits. In particular, each Pauli matrix corresponds to a rotation around the respective axis on the Bloch sphere. For example,

$${σ}_{x} = ( \begin{matrix}0 & 1 \\ 1 & 0\end{matrix} ) , {σ}_{y} = ( \begin{matrix}0 & - i \\ i & 0\end{matrix} ) and {σ}_{z} = ( \begin{matrix}1 & 0 \\ 0 & - 1\end{matrix} ) .$$

Any change or displacement to the quantum state of the qubit (e.g., due to a weak interaction, a small rotation, or a short period of evolution under a Hamiltonian) can be described as a change or displacement of the Bloch vector \vec{r} by Δ\vec{r}·\vec{σ}=Δrₓσₓ+Δr_{y}σ_{y}+Δr_{z}σ_{z}, which can start from a quantum state close to the maximally mixed state (∥\vec{r}∥₂→0).

The effect of a noisy quantum channel on the Bloch radius can be described by the affine transformation \vec{r}^{(t+1)}=\hat{M}·\vec{r}^{(t)}+\vec{t}, where \vec{r}^{(t)} is the Bloch radius at a time step t, \vec{r}^{(t+1)} is the Bloch radius at time step t+1 after noise is added, \hat{M} is a linear transformation matrix representing linear transformation(s) of the affine transformation (e.g., scaling, rotation and/or shearing of \vec{r}^{(t)}), and \vec{t} is a translation vector representing a translational transformation of the affine transformation. The inverse quantum channel that reverses the noise introduced by the quantum channel to recover the original quantum state of the qubit can therefore be represented as: \vec{r}^{(t)}=\hat{M}⁻¹·(\vec{r}^{(t+1)}−\vec{t}), where \hat{M}⁻¹ is the inverse linear transformation matrix. Because the quantum channel weakly disturbs the quantum state, the affine transformation representing the quantum channel can also be written to take into account any prior knowledge of the measurement strength parameter ε as follows: \vec{r}^{(t+1)}=(1−ε)\vec{r}^{(t)}+ε(\hat{M}·\vec{r}^{(t)}+\vec{t}).

\hat{M} and \vec{t} can be defined in accordance with the type of noisy quantum channel being represented. In the illustrative depolarizing channel example described above, which can map pure states toward the maximally mixed state, \hat{M} can be defined as a scaled identity matrix that shrinks the Bloch sphere and \vec{t} can be the zero vector.

The following will now describe further details of the forward diffusion process. As mentioned above, a quantum channel can be represented by equation (7) as follows:

$${ℳ}^{( 1 …T )} ( ρ ) = {\prod }_{t = 1}^{T} ( {⊗}_{i = 1}^{N} {ℳ}_{i} ( {ρ}_{i}^{t} ) ) = {\prod }_{t = 1}^{T} ( ℳ ( {ρ}^{t} ) ) .$$

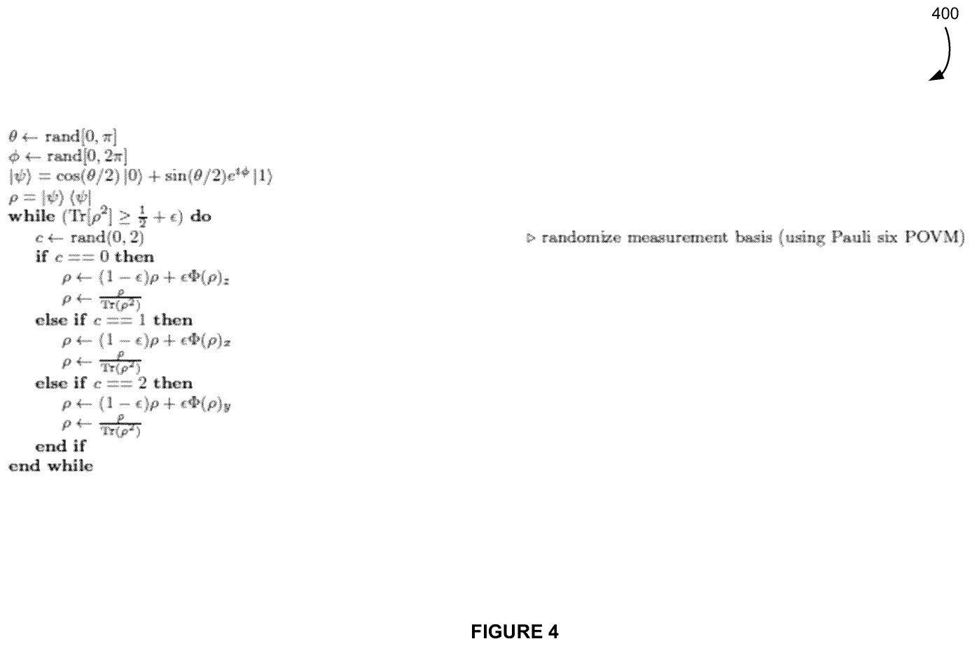

The forward diffusion process can be further performed based on a finite set of POVM elements, where the trivial case is the Paul six POVM. The quantum channel being simulated by the weak measurements can be randomized using a forward diffusion process algorithm, where the measurement strength can be the same for each randomized measurement. A first quantum state can be weakly measured until it is mapped to a fully-noised quantum state (e.g., transformed into the maximally mixed state or a near-maximally mixed state). At this point, the quantum channel is well-defined and can be applied to other examples. Further details regarding implementing the forward diffusion process will now be described below with reference to FIG. 4.

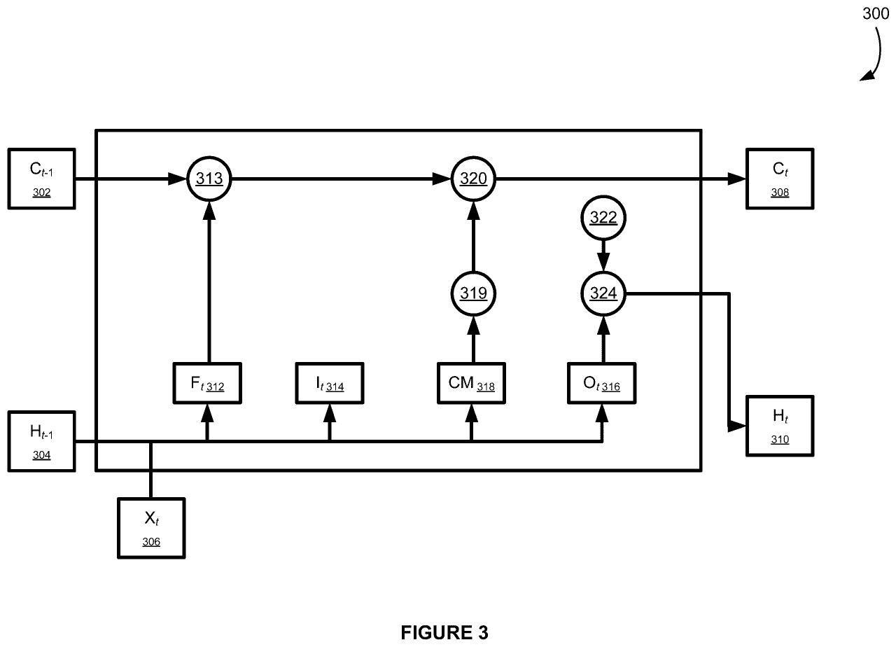

FIG. 3 is a diagram of machine learning model architecture (“architecture”) 300, in accordance with at least one embodiment. The architecture 300 can be used to implement a machine learning model (e.g., quantum diffusion model process) that can perform noisy quantum channel error mitigation. More specifically, the architecture 300 represents an LSTM.

As shown in FIG. 3, the LSTM receives input data at a current time step t. In at least one embodiment, the input data includes three input data items (e.g., vectors). The three input data items include the cell state generated by the LSTM during the previous time step t-1 (“Cₜ₋₁”) 302, the hidden state at the previous time step t-1 (“Hₜ₋₁”) 304 and an external data item provided to the LSTM at the current time step t (“Xₜ”) 306. Cₜ₋₁ 302 serves as the long-term memory of the network by preserving information across many time step, while Hₜ₋₁ 304 captures short-term dependencies by capturing information relevant to the current time step. Xₜ 306 can represent new data or features relevant to the current time step t, such as measurement outcomes or encoded quantum information.

The LSTM can use the input data to generate the cell state during the current time step t (“Cₜ”) 308 and the hidden state during the current time step t (“Hₜ”) 310. Hₜ 310 can be used for downstream tasks or passed to subsequent layers. The performance of the LSTM can be evaluated based on this output, as it reflects the ability of the LSTM to capture and utilize relevant temporal data dependencies.

To generate Cₜ 308 and Hₜ310, the architecture 300 can further include a set of gates. The set of gates can enable the LSTM to learn temporal patterns and dependencies in sequential data by combining the recent past information represented by Hₜ₋₁ 304 with the new data or features represented by Xₜ 306, thereby updating the long-term memory represented by Cₜ₋₁ 302. Specifically, the set of gates determines how information is retained, updated, or discarded, transforming the values of Cₜ₋₁ 302 and Hₜ₋₁ 304 into Cₜ 308 and Hₜ 310. Architecturally, each gate of the set of gates can be implemented as a dedicated neural network layer that includes an activation function to regulate the flow of information. In at least one embodiment, the activation function of at least one gate is the sigmoid function, which outputs values between 0 and 1 to control the degree of information passage. The gates are used to generate the updated cell and hidden states by selectively filtering and combining the relevant information from previous states and current inputs. For example, as shown in FIG. 3, the set of gates can include a forget gate (Fₜ) 312, an input gate (Iₜ) 314, and an output gate (Oₜ) 316. Each of the gates 312-316 can be provided with a same gate input formed by combining Hₜ₋₁ 304 and Xₜ 306 (e.g., concatenated together in a gate input vector).

The forget gate 312 evaluates the gate input to determine which portions of the previous cell state Cₜ₋₁ 302 should be retained or discarded, and subsequently generates an updated cell state 313 derived from Cₜ₋₁ 302. Specifically, the forget gate 312 produces a forget gate selector data item, typically as a selector vector with values ranging between 0 and 1. Each element of this selector vector can correspond to a respective element in Cₜ₋₁ 302 and acts as a multiplicative mask. For example, a value closer to 1 allows the corresponding information to be retained, while a value closer to 0 causes that information to be discarded. The updated cell state 313 is computed by performing element-wise multiplication between the forget gate selector vector and Cₜ₋₁ 302. This enables the LSTM to selectively preserve or remove information from Cₜ₋₁ 302, which can facilitate long-term memory retention or forgetting (as necessary).

The input gate 314 determines the extent to which new information from Xₜ 306 should be incorporated into Cₜ 308. To facilitate this, the architecture 300 may include a candidate memory component (CM) 318, which can be implemented as a separate neural network layer. CM 318 can generate a candidate memory data item, typically represented as a candidate memory vector. In at least one embodiment, the output neurons of CM 318 apply a candidate memory value function to ensure that all elements of the candidate memory vector are constrained within a given range. For example, the given range can be from −1 to 1. One example of a candidate memory value function that can be used to ensure that all elements of the candidate memory vector are constrained within the range of −1 to 1 is the hyperbolic tangent function (tanh).

The input gate 314 produces an input gate selector data item, often in the form of a selector vector with values between 0 and 1. This selector vector is used to modulate the candidate memory vector through element-wise multiplication, resulting in a cell state modification data item (“data item”) 319. This operation allows the network to control the degree to which each element of the candidate memory vector influences the cell state update.

The resulting data item 319 can then be combined with the updated cell state 313 at a combiner 320 to produce the new cell state Cₜ 308. In at least one embodiment, the combiner 320 performs an element-wise addition of the data item 319 and the updated cell state 313 to generate Cₜ 308. This process enables the LSTM to selectively integrate new information while retaining relevant aspects of Cₜ₋₁ 302, which can support both learning of new patterns and preservation of long-term dependencies.

The output gate 316 can determine the value of Hₜ 310, which is an output that can be used as input at the next time step t+1. To accomplish this, the output gate 316 can generate an output gate selector data item (e.g., selector vector) based on Hₜ 304 and Xₜ 306. The architecture 300 can include a cell state normalizer 322, which applies a nonlinear activation function to the cell state Cₜ 308 produced by the combiner 320. This normalization ensures that the values of Cₜ308 are constrained within a range, typically between −1 and 1 (e.g., using tanh), which helps stabilize training and prevents the cell state from growing unbounded. The output gate selector data item and the normalized cell state are then combined using a combiner 324, which typically performs element-wise multiplication, to generate Hₜ 310. This mechanism allows the LSTM to control how much of the cell state's information is exposed at each time step, enabling selective output of relevant information.

The LSTM represented by architecture 300 can be trained using any suitable technique. In at least one embodiment, the LSTM is trained using backpropagation, specifically backpropagation through time (BPTT). In BPTT, gradients are propagated backward through the sequence of time steps, allowing the model to learn temporal dependencies. The effectiveness of BPTT can depend on the cell state, as the gradients with respect to the cell state at each time step influence how information is retained or forgotten. The gradient calculation for backpropagation through time can be determined, at least in part, by the ratio of change between Cₜ 308 and Cₜ₋₁ 302 (e.g., ∂Cₜ/∂Cₜ₋₁), where this ratio reflects the combined effects of the forget, input, and output gates 312-316, as well as CM 318. By adjusting these components during training, the LSTM can learn to control the flow of information and manage long-term dependencies to optimize performance for the task of recovering original quantum state data from noisy quantum state data.

The following sets forth an exemplary, non-limiting procedure for training the LSTM of FIG. 3 to approximate the inverse of an arbitrary, non-unitary quantum channel and thereby map noisy quantum state data back to corresponding noise-free (original) quantum state data. Unless otherwise indicated, all variables, notation, and reference numerals correspond to those already introduced elsewhere in the present specification.

In at least one embodiment, a supervised learning task is used to train the LSTM. The supervised learning task is formalized as training the LSTM to learn the function F_{θ}: ρ^{T}→ρ⁰ where ρ^{T} denotes the density matrix represented a fully-noised quantum state after T interactions with a non-unitary (noisy) quantum channel M, ρ⁰ is the density matrix representing the LSTM's prediction of the original quantum state (e.g., pure quantum state), and θ is a parameter including all trainable weights and biases of the LSTM.

To train the LSTM, a random pure quantum state can be initialized. More specifically, initializing the random pure quantum state can include initializing a polar angle parameter θ to a randomly selected value between 0 and π, inclusive, initializing an azimuthal angle parameter φ to a randomly selected value between 0 and 2π, inclusive, and initializing an original (e.g., pure) quantum state vector representing the original (e.g., pure) quantum state |ψ [symbol] as

$$cos ( \frac{θ}{2} ) \vert 0 〉 + sin ( \frac{θ}{2} ) {e}^{i ϕ} \vert 1 〉 .$$

Then, a forward diffusion process can be performed to add noise to the original quantum state. The output of the forward diffusion process can be recorded as a training example. For example, FIG. 4 is a forward diffusion process algorithm (“algorithm”) 400, in accordance with at least one embodiment. As shown in FIG. 4, a random pure quantum state is initialized. More specifically, as described above with reference to FIG. 3, initializing the random pure quantum state includes initializing a polar angle parameter θ to a randomly selected value between 0 and π, inclusive, initializing an azimuthal angle parameter φ to a randomly selected value between 0 and 2π, inclusive, initializing the pure quantum state vector

$$\vert ψ 〉 as cos ( \frac{θ}{2} ) \vert 0 〉 + sin ( \frac{θ}{2} ) {e}^{i ϕ} \vert 1 〉 ,$$

and initializing the density matrix ρ as |ψ [symbol] ψ|.

After initializing the set of parameters, a while loop is initiated. The while loop continues to be performed as long as a threshold quantum state purity condition is satisfied. In this example, quantum state purity is defined by the trace of ρ², Tr(ρ²). For a pure state, Tr(ρ²)=1 and for a maximally mixed state

$$Tr ( {ρ}^{2} ) = \frac{1}{d}$$

where d is the dimension of the associated Hilbert space. In the example of a single qubit (as shown in FIG. 4), the associated Hilbert space has two dimensions (d=2), and Tr(ρ²) for the single qubit in the maximally mixed state is ½. The while loop continues to operate as long as Tr(ρ²) is greater than or equal to

$$\frac{1}{2} + ϵ .$$

That is, the quantum state in this example represents a qubit. However,

$$\frac{1}{2} + ϵ$$

may be generalized to

$$\frac{1}{d} + ϵ$$

in other embodiments in which the quantum state does not correspond to a single qubit.

During the while loop, a random basis measurement is applied to the density matrix, which changes the density matrix. For example, the Pauli six POVM set can be used as a measure. However, any suitable POVM set can be used. For example, a value c can be randomly selected as 0, 1 or 2. Without loss of generality, c==0 corresponds to the application of a z-basis measurement, c==1 corresponds to the application of an x-basis measurement, and c==2 corresponds to the application of a y-basis measurement as shown in FIG. 4 (similar to equation (2) described above). After applying the randomly selected basis measurement, ρ is updated to

$$\frac{ρ}{Tr ( {ρ}^{2} )} .$$

If Tr(ρ²) is still greater than or equal to

$$\frac{1}{2} + ϵ ,$$

then another random basis measurement is applied. Otherwise, the process ends. Thus, the number of iterations of the while loop can correspond to the number of weak measurements that can take the original quantum state to the maximally mixed state or the near-maximally mixed state, which is controlled by the magnitude of ϵ. After each measurement, the updated density matrix of the quantum state can be stored and normalized as follows:

$${ρ}^{( t + 1 )} = \frac{{ℳ}^{{O}_{t}} ( {ρ}^{( t )} )}{Tr ( {ℳ}^{{O}_{t}} ( {ρ}^{( t )} ) {( {ℳ}^{{O}_{t}} ( {ρ}^{( t )} ) )}^{†} )} \qquad ( 9 )$$

where Oₜ is the observable measured in the t-th iteration of the while loop.

Referring back to FIG. 3, a real-valued tensor encoding process can be performed. In at least one embodiment, for product states, the input features of the machine learning model are defined as follows: [N, S, 2, D, 2, 2], where N is number of examples (batch size), Sis the sequence length, 2 defines real and imaginary, D is the number of qubits, and 2, 2 defines a 2×2 size of the density matrix representing the quantum state. The data loader class can convert the input features into converted features [N, S, 8D]. In at least one embodiment, for non-separable states, the input features of the machine learning model are defined as follows: [N, S, 2, 2^{D}, 2^{D}], and the input features can be converted into [N, S, 2^{D+1}].

Any suitable parameters θ can be initialized in accordance with embodiments described herein. For example, forget gate biases can be set to 1 to encourage initial memory retention. As another example, the batch size N can be selected to utilize parallel processing without memory overflow (e.g., N=64).

A loss function used during the training procedure can be defined. The loss function can be used to calculate a distance metric. In at least one embodiment, the loss function includes a mean square error (MSE) loss term L_{MSE}, which has similar properties to a Euclidean norm described above. The loss function can include additional loss terms. In at least one embodiment, the loss function further includes a fidelity loss term L_{FID} corresponding to a measure of similarity between the true and predicted density matrices. For example, the fidelity can correspond to Uhlmann fidelity. Accordingly, in at least one embodiment, the loss function is defined as L_{MSE}+L_{FID}.

The input quantum state data of the machine learning model can be represented by the density matrix

$${ρ}_{i}^{( t )} = ( \begin{matrix}{α}_{1} + i {α}_{2} & {β}_{1} + i {β}_{2} \\ {γ}_{1} + i {γ}_{2} & {δ}_{1} + i {δ}_{2}\end{matrix} )$$

having trace 1. If the machine learning model is trained on multiple qubits, then the input quantum state data of the machine learning model can become

$${\tilde{ρ}}_{i}^{( t )} = {⊗}_{k = 1}^{d} {ρ}_{i}^{( t , k )} , where {ρ}_{i}^{( t , k )} = ( \begin{matrix}{α}_{1 , k} + i {α}_{2 , k} & {β}_{1 , k} + i {β}_{2 , k} \\ {γ}_{1 , k} + i {γ}_{2 , k} & {δ}_{1 , k} + i {δ}_{2 , k}\end{matrix} ) .$$

Since the machine learning model can operate in the real algebraic field R rather than the complex field C, the input quantum state data should be represented by real numbers. For example, the values of the diagonal of the density matrix

$${ρ}_{i}^{( t )}$$

can be real, and the density matrix

$${ρ}_{i}^{( t )}$$

can be a Hermitian matrix. Consequently, for a two-state quantum system, the input quantum state data can be represented by a 1×8 dimension vector for each iteration in a sequence of the form

$${u}_{i}^{( t )} = [ {α}_{1} , {β}_{1} , {γ}_{1} , {δ}_{1} , {α}_{2} , {β}_{2} , {γ}_{2} , {δ}_{2} ] ,$$

and the output of the machine learning model can be the next approximate state. One or more of the features of the vector can have a zero value. This effectively creates a pure quantum state from a mixed quantum state through amplifications and predetermined rotations, which are the parameters of the inverse quantum channel and effectively act as a purification protocol.

Regarding the training procedure, the LSTM can be trained any suitable number of input examples of quantum states that go through the randomized non-unitary quantum channel created via the addition of noise to the initial quantum state.

In at least one embodiment, the training procedure includes performing a batch assembly process by randomly sampling N samples from the training set. Input training data (e.g., input tensors) including reverse-time-ordered sequences can be constructed so that t₀ corresponds to ρ^{T} and T corresponds to ρ⁰. The input training data can be fed through the LSTM to determine, for each sample i∈N of the input training data, ρ⁰ for sample i. Then, the loss can be computed using the loss function described above. After computing the loss, BPTT can be performed to update θ. When updating θ, the parameters should maintain the evolution of the quantum state within an acceptable quantum mechanical regime. Hyper-parameters governing the simulation of the noisy quantum channel may be varied across training samples to enhance robustness to unseen noise levels. The architecture 300 may be augmented with additional components, such as attention mechanisms, bidirectional LSTM layers, etc., provided causality constraints remain satisfied. Regularization, such as via weight decay and/or early stopping, can be used to prevent over-fitting.

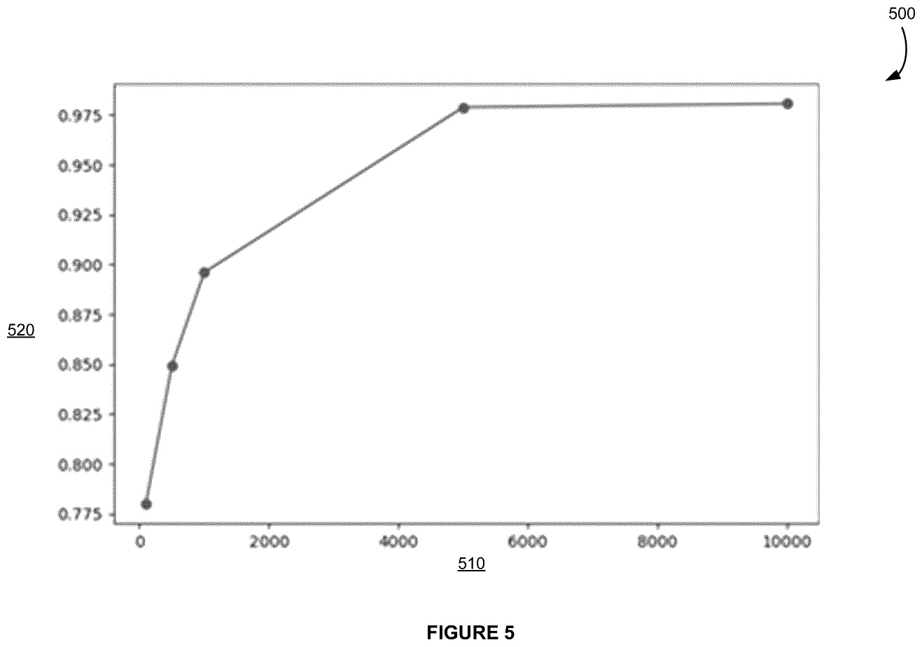

To monitor the training procedure, average fidelity can be computed on a validation set after each training epoch. For example, FIG. 5 is a graph 500 illustrating the average fidelity as a function of the number of training examples, according to at least one embodiment. In particular, the graph 500 includes an x-axis 510 corresponding to the number of training examples ranging from 100 to 10,000, and a y-axis 520 corresponding to the average fidelity. The machine learning model used included an LSTM having 250 hidden layers and 3 main layers, and the sequence length of the examples was 17 steps. In this illustrative example, c=0.3 and the lower bound purity is T r(ρ²)=0.7. As can be seen by the graph 500, the average fidelity of the machine learning model hit a plateau at around 0.975. This is due at least in part to the small number of parameters that the machine learning model can have compared to the small changes that occur during each iteration. Accordingly, different models may achieve better performance (e.g., an average fidelity of at least about 0.999).

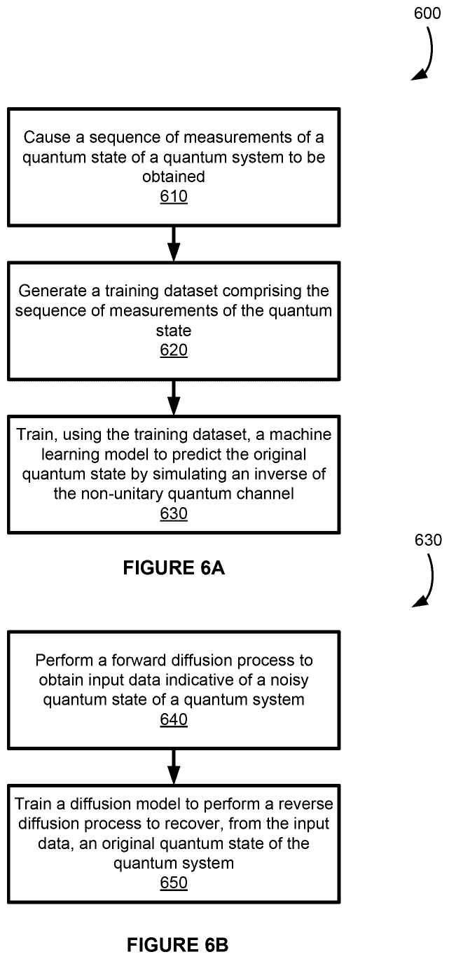

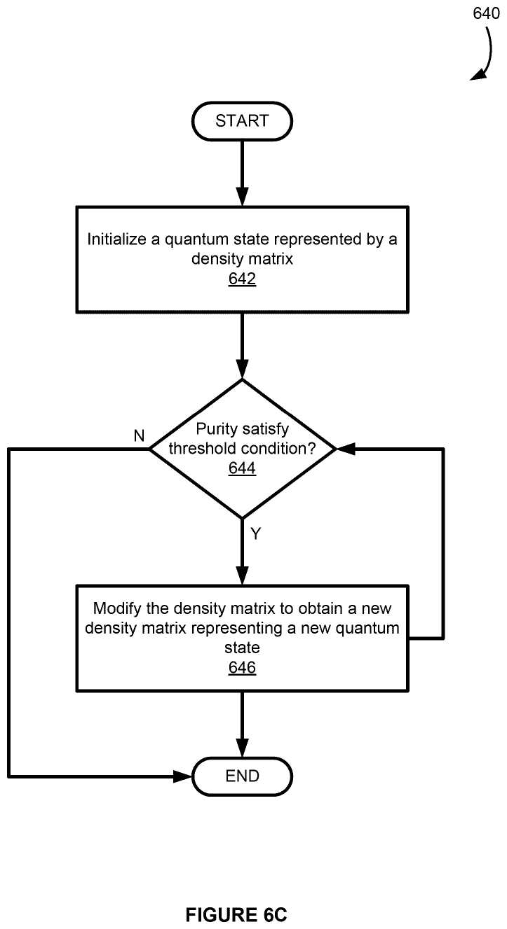

FIG. 6A is a flowchart illustrating a method 600 for training a machine learning model to implement noisy quantum channel error mitigation, in accordance with at least one embodiment.

At operation 610, processing logic causes a sequence of measurements of a quantum state of a quantum system to be obtained. In at least one embodiment, the sequence of measurements of the quantum state is a sequence of weak measurements of the quantum state that does not fully collapse a wave function corresponding to the quantum state. In at least one embodiment, the sequence of measurements of the quantum state includes multiple measurements of the quantum state captured in a temporal order.

At operation 620, processing logic generates a training dataset including the sequence of measurements of the quantum state.

At operation 630, processing logic trains, using the training dataset, a machine learning model to predict the original quantum state by simulating an inverse of the non-unitary quantum channel. More specifically, the machine learning model is trained to predict the original quantum state in order to perform error mitigation. In at least one embodiment, the original state is a pure quantum state.

In at least one embodiment, the machine learning model is a diffusion model. In at least one embodiment, the machine learning model includes a recurrent neural network.

In at least one embodiment, training the machine learning model to predict the original quantum state by simulating the inverse of the non-unitary quantum channel includes performing a reverse diffusion process to predict a backward evolution of noise added to the original quantum state in accordance with a forward diffusion process. Further details regarding operations 610-630 are described above with reference to FIGS. 1-5 and will now be described below with reference to FIGS. 6B-6C.

FIG. 6B is a flowchart illustrating an example method for performing the operation 630 of FIG. 6A to train a machine learning model, in accordance with at least one embodiment.

At operation 640, processing logic performs a forward diffusion process to obtain input data indicative of a noisy quantum state of a quantum state. More specifically, the noisy quantum state is a pure quantum state modified by an amount of noise. In at least one embodiment, the noisy quantum state is a fully-noised quantum state. In at least one embodiment, the noisy quantum state is a maximally mixed quantum state.

In at least one embodiment, the forward diffusion process includes one or more iterations. In at least one embodiment, training the machine learning model to predict the original quantum state by simulating the inverse of the non-unitary quantum channel includes performing each iteration of the one or more iterations of the forward diffusion process by initializing a first quantum state represented by a first density matrix associated with a Hilbert space, determining, based on the density matrix, whether a purity of the first quantum state satisfies a threshold condition defined based on a maximally mixed quantum state for the Hilbert space, and in response to determining that the purity of the first quantum state satisfies the threshold condition, modifying the first density matrix to obtain a second density matrix representing a second quantum state. In at least one embodiment, determining whether the purity of the first quantum state satisfies the threshold condition comprises determining whether a purity determined from a trace performed using the first density matrix is greater than or equal to a threshold value (e.g., in an extreme case the threshold value can be defined based on a purity determined from a trace performed using a density matrix representing the maximally mixed quantum state). In at least one embodiment, modifying the first density matrix to obtain the second density matrix includes applying a randomly selected weak measurement to the first density matrix. An example implementation of the forward diffusion process is described above with reference to FIG. 4 and will be described below with reference to FIG. 6C.

At operation 650, processing logic trains a diffusion model to perform a reverse diffusion process to recover, from the input data, an original quantum state of the quantum system. Further details regarding operations 640-650 are described above with reference to FIGS. 1-6A and will now be described below with reference to FIG. 6C.

FIG. 6C is a flowchart illustrating an example method for performing the operation 640 of FIG. 6B to perform a forward diffusion process, in accordance with at least one embodiment.

At operation 642, processing logic initializes a quantum state represented by a density matrix associated with a Hilbert space. In at least one embodiment initializing the quantum state includes initializing a set of parameters. In at least one embodiment, initializing the quantum state includes initializing a set of angles for defining a Bloch sphere representation of the quantum state. In at least one embodiment, the set of angles includes a polar angle, and an azimuthal angle. In at least one embodiment, initializing the set of angles includes randomly selecting a value of the polar angle. In at least one embodiment, initializing the set of angles includes randomly selecting a value of the azimuthal angle. In at least one embodiment, initializing the set of parameters includes initializing the quantum state based on the set of angles. In at least one embodiment, initializing the set of parameters includes initializing the density matrix based on the quantum state.

At operation 644, processing logic determines whether a purity of the quantum state satisfies a threshold condition defined based on a maximally mixed quantum state for the Hilbert space. In at least one embodiment, determining whether the purity of the first quantum state satisfies the threshold condition includes determining whether a trace determined from the density matrix is greater than or equal to a threshold value defined based on a trace determined for the maximally mixed quantum state (e.g., the trace of the maximally mixed quantum state for a single qubit is ½). In at least one embodiment, the threshold value is defined as the sum of the trace determined for the maximally mixed quantum state and an error value greater than or equal to zero.

If the purity of the quantum state does not satisfy the threshold condition, this means that enough noise has been added to the quantum state and the forward diffusion process ends. Otherwise, at operation 646, processing logic modifies the density matrix to obtain a new density matrix representing a new quantum state. In at least one embodiment, modifying the density matrix to obtain the new density matrix includes applying a randomly selected basis measurement to the density matrix. In at least one embodiment, the randomly selected basis measurement corresponds to the x-axis. In at least one embodiment, the randomly selected basis measurement corresponds to the y-axis. In at least one embodiment, the randomly selected basis measurement corresponds to the z-axis.

After modifying the density matrix to obtain the new density matrix, the forward diffusion process then reverts back to operation 644 to determine whether the purity of the new quantum state satisfies the threshold condition. Further details regarding operations 642-646 are described above with reference to FIGS. 4 and 6B.

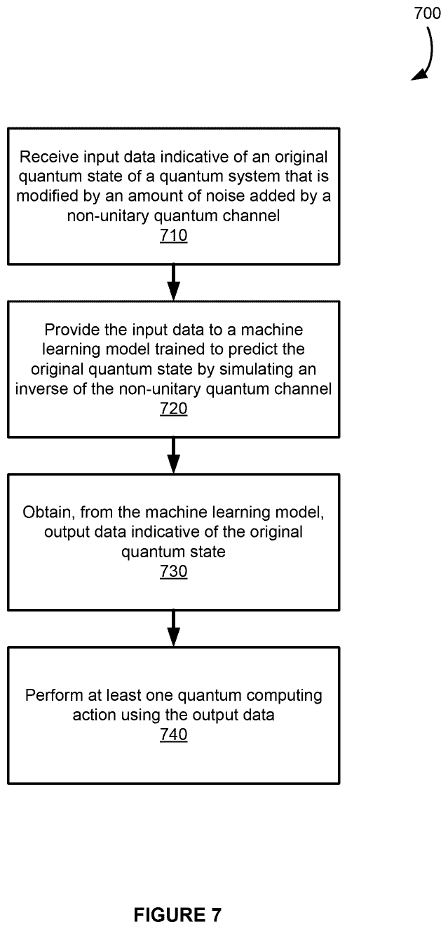

FIG. 7 is a flowchart illustrating an example method for using a trained machine learning model to implement noisy quantum channel error mitigation, in accordance with at least one embodiment.

At operation 710, processing logic receives input data indicative of an original quantum state of a quantum system that is modified by an amount of noise added by a non-unitary quantum channel. For example, the original quantum state can be transmitted by a first quantum computing system, through the quantum channel, to a second quantum computing system.

At operation 720, processing logic provides the input data to a machine learning model trained to predict the original quantum state by simulating an inverse of the non-unitary quantum channel. More specifically, the machine learning model is trained to predict the original quantum state in order to perform error mitigation. In at least one embodiment, the machine learning model is a diffusion model. In at least one embodiment, the machine learning model includes a recurrent neural network.

In at least one embodiment, the machine learning model is trained by simulating one or more non-unitary quantum channels, including the non-unitary quantum channel, based on one or more sequences of measurements of one or more quantum states, where each sequence of measurements of a quantum state includes multiple measurements of the quantum state captured in a temporal order. In at least one embodiment, each sequence of measurements of the quantum state is a sequence of weak measurements of the quantum state that does not fully collapse a wave function corresponding to the quantum state.

In at least one embodiment, the machine learning model is trained to perform a reverse diffusion process to predict a backward evolution of noise added to the original quantum state by a forward diffusion process. In at least one embodiment, the forward diffusion process includes one or more iterations, wherein each iteration of the one or more iterations of the forward diffusion process is performed by initializing a first quantum state represented by a first density matrix associated with a Hilbert space, determining, based on the density matrix, whether a purity of the first quantum state satisfies a threshold condition defined based on a maximally mixed quantum state for the Hilbert space, and in response to determining that the purity of the first quantum state satisfies the threshold condition, apply a random basis measurement to the first density matrix to obtain a second quantum state associated with a second density matrix.

At operation 730, processing logic obtains, from the machine learning model, output data indicative of the original quantum state. More specifically, the original quantum state refers to the quantum state of the quantum system prior to being transmitted through the noisy quantum channel. For example, the output data can be indicative of the original state of a qubit transmitted through the noisy quantum channel.

In at least one embodiment, the input data includes modified message corresponding to an original message modified by the amount of noise, and the output data comprises a prediction of the original message. In at least one embodiment, the input data corresponds to one or more optical qubits. For example, the one or more optical qubits can be transferred between computing systems over long distances, and the machine learning model can be used to clean the noisy quantum state before it goes to the next quantum computing system. In at least one embodiment, the machine learning model identifies at least one noise type added by the non-unitary quantum channel.

At operation 740, processing logic performs at least one quantum computing action using the output data. In at least one embodiment, the at least one quantum computing action includes sending, to a quantum computing system, data indicative of the original quantum state predicted by the machine learning model. In at least one embodiment, the at least one quantum computing action includes performing quantum sensing and/or metrology to improve measurement precision. In at least one embodiment, the at least one quantum computing action includes performing quantum simulation for generating one or more models with enhanced precision. In at least one embodiment, the at least one quantum computing action includes performing at least one quantum cryptography operation. In at least one embodiment, performing at least one quantum cryptography operation includes performing quantum key distribution with enhanced precision.

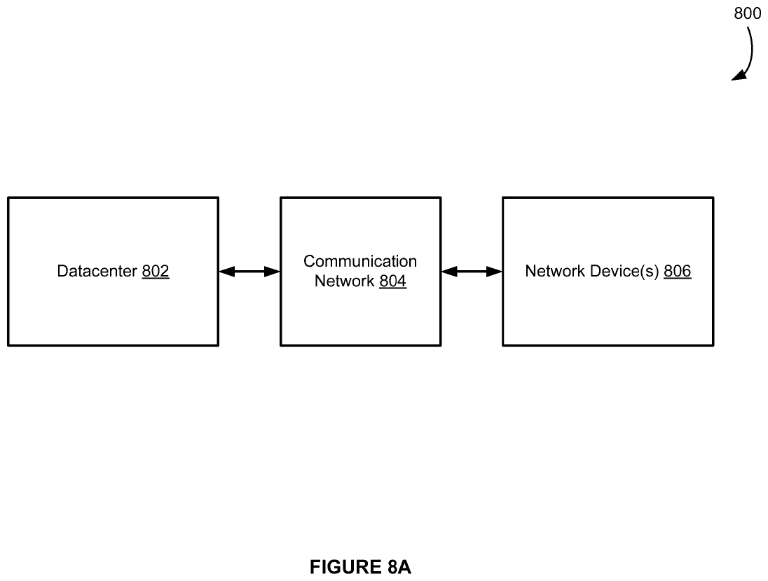

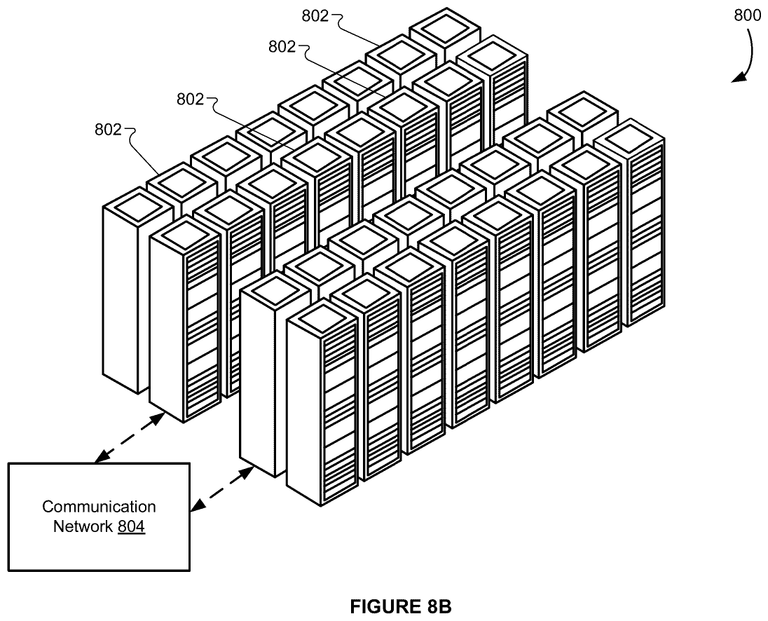

FIGS. 8A-8B are diagrams illustrating a network architecture 800 that can be used to implement quantum communication protocols, in accordance with at least one embodiment. For example, the network architecture 800 may include a datacenter 802, a communication network 804, and network device(s) 806. The network architecture 800 may illustrate a general computing architecture within which more specific systems and/or subsystems may function.

For example, the datacenter 802 may be a centralized facility designed to house computing resources and related components. The datacenter 802 may operate to support the infrastructure required for advanced computational tasks, for efficient, secure, and reliable operations. The datacenter 802 may include the building and structural components, including power supplies, cooling systems, fire suppression systems, and physical security measures that are configured to maintain optimal operating conditions and/or protect the equipment from environmental hazards and unauthorized access. The datacenter 802 may include high-performance servers or compute nodes, often arranged in racks as shown in network architecture 800, and connected through high-speed networks as described herein. These servers may include processors referred also in the present disclosure as processing device (e.g., central processing units (CPUs), graphics processing units (GPUs), data processing units (DPUs) and/or the like), quantum processing units (QPUs), a plurality of parallel processing units (PPUs), and application-specific integrated circuits (ASICs). memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications. QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

The datacenter 802 may include high-speed network equipment, such as network switches, routers, firewalls, and/or the like to facilitate fast and secure data transmission within the datacenter 802 (e.g., between the servers or compute nodes) and between external networks. The datacenter 802 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 802 may support high-performance computing tasks. Examples of various network topologies may include hierarchical networking topologies such as the fat tree topology, Slim Fly topology, Dragonfly topology, and/or the like.

The communication network 804 may communicably couple the datacenter 802 with network device(s) 806 and other external devices for data exchange and connectivity. Examples of the communication network 804 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 804 to incorporate multiple network types and configurations may allow the datacenter 802 to adapt to diverse application needs, from general data communication to specialized HPC tasks. As described herein, the communication network 804 may leverage various optical components to establish communication links (e.g., communicably couple) between components in the architecture 800. As such, the communication network 804 may include various optical devices, transceivers, modules, and/or the like that are configured to generate optical signals (e.g., provide optical transmitter functionality) and/or receive optical signals (e.g., provide optical receiver functionality).

The network device(s) 806 may include a variety of computing devices capable of transmitting and receiving signals over the communication network 804. The network device(s) 806 may range from personal computing devices to complex server configurations. Examples include Personal Computers (PCs), laptops, tablets, smartphones, and servers. The network device(s) 806 may facilitate user interactions with the datacenter 802, allowing for data input, retrieval, and processing from remote locations. In addition to individual computing devices, the network device(s) 806 may also include collections of servers or additional datacenters. For instance, these could be other datacenters similar to or the same as datacenter 802. Such an interconnection may allow for the formation of a distributed computing environment for improved redundancy, load balancing, and disaster recovery capabilities. By linking multiple datacenters, the network architecture 800 may leverage geographically dispersed resources, optimizing performance and ensuring high availability.

As described herein, the datacenter 802 and/or the network device(s) 806 may include storage devices and processing circuitry for executing computing tasks, such as controlling the flow of data internally and over the communication network 804. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

Each network device 806 may include or be connected to a power distribution unit (PDU) that supplies power to power consuming elements of the network devices 806 (e.g., to the individual network switches within each network device). Related art PDUs may take the form of many power interfaces (e.g., AC and/or DC power outlets) integrated into a single power strip, which requires cumbersome power cable routing and complicated assembly/disassembly. In addition, these power strips cannot be easily replaced. For example, replacement or repair of one or a few of the outlets of the PDU or other elements of the PDU may require powering off the entire strip and disconnecting each power cable before installing a new power strip and reconnecting the power cables to each outlet. This process is time consuming and may result in unnecessary replacement of functioning parts of the PDU that are integrated with non-functioning parts of the PDU. In order to address these and other shortcomings of the related art, example embodiments provide PDUs capable of blind-mating or direct connection with power consuming elements within the network devices 806. In addition, PDUs according to example embodiments may be modular and function together to provide power to consumers so that replacement or repair of one non-functioning PDU module does not interrupt power to consumers of the network device connected to functioning PDU modules.

In addition, although not explicitly shown, the present disclosure contemplates that the datacenter 802 and network device(s) 806 may include one or more communication interfaces for facilitating wired and/or wireless communication between one another and other unillustrated elements of the network architecture 800. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 800.

Furthermore, the present disclosure contemplates that the network architecture 800 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 800 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 800.

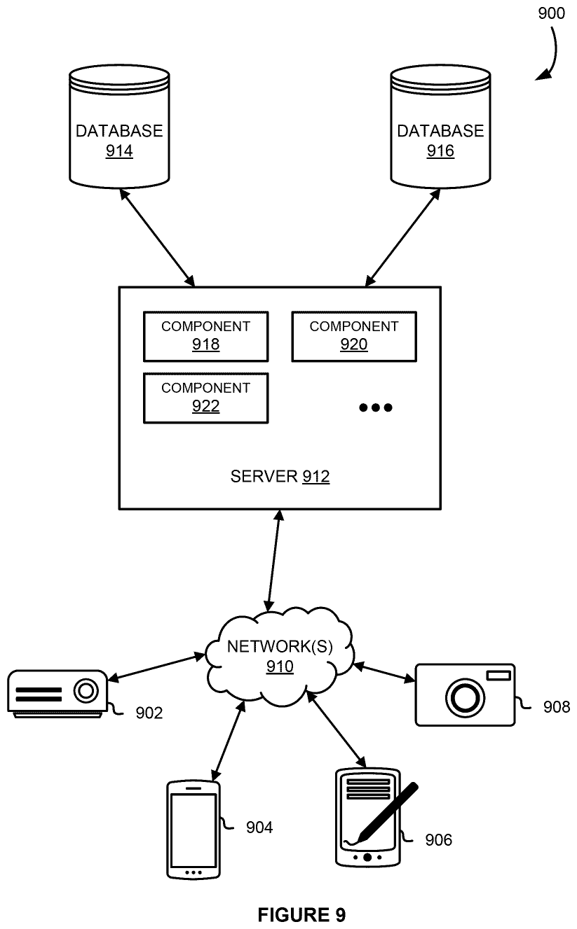

FIG. 9 illustrates a distributed system 900 that can be used to implement quantum communication protocols, in accordance with at least at least one embodiment. In at least one embodiment, distributed system 900 includes one or more client computing devices 902, 904, 906, and 908, which are configured to execute and operate a client application such as a web browser, proprietary client, and/or variations thereof over one or more network(s) 910. In at least one embodiment, server 912 may be communicatively coupled with remote client computing devices 902, 904, 906, and 908 via network 910. In at least one embodiment, server 912 includes a PCB having one or more power connectors as described herein above. In at least one embodiment, server 912 receives electrical power via a power delivery system as described herein above.

In at least one embodiment, server 912 may be adapted to run one or more services or software applications such as services and applications that may manage session activity of single sign-on (SSO) access across multiple datacenters. In at least one embodiment, server 912 may also provide other services or software applications can include non-virtual and virtual environments. In at least one embodiment, these services may be offered as web-based or cloud services or under a Software as a Service (SaaS) model to users of client computing devices 902, 904, 906, and/or 908. In at least one embodiment, users operating client computing devices 902, 904, 906, and/or 908 may in turn utilize one or more client applications to interact with server 912 to utilize services provided by these components.

In at least one embodiment, software components 918, 920 and 922 of the distributed system 900 are implemented on server 912. In at least one embodiment, one or more components of the distributed system 900 and/or services provided by these components may also be implemented by one or more of client computing devices 902, 904, 906, and/or 908. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 900. The embodiment shown in FIG. 9 is thus one example of a distributed system for implementing an embodiment system and is not intended to be limiting.

In at least one embodiment, client computing devices 902, 904, 906, and/or 908 may include various types of computing systems. In at least one embodiment, a client computing device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (e.g., a Microsoft Xbox gaming console with or without a Kinect® gesture input device), and/or a personal messaging device, capable of communicating over network(s) 910. Although distributed system 900 is shown with four client computing devices, any number of client computing devices may be supported. Other devices, such as devices with sensors, etc., may interact with server 912.

In at least one embodiment, network(s) 910 in distributed system 900 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, network(s) 910 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

In at least one embodiment, server 912 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 912 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 912 using software defined networking. In at least one embodiment, server 912 may be adapted to run one or more services or software applications.

In at least one embodiment, server 912 may run any operating system, as well as any commercially available server operating system. In at least one embodiment, server 912 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 912 may include one or more applications to analyze and consolidate data feeds and/or event updates received from users of client computing devices 902, 904, 906, and 908. In at least one embodiment, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and/or variations thereof. In at least one embodiment, server 912 may also include one or more applications to display data feeds and/or real-time events via one or more display devices of client computing devices 902, 904, 906, and 908.

In at least one embodiment, distributed system 900 may also include one or more databases 914 and 916. In at least one embodiment, databases may provide a mechanism for storing information such as user interactions information, usage patterns information, adaptation rules information, and other information. In at least one embodiment, databases 914 and 916 may reside in a variety of locations. In at least one embodiment, one or more of databases 914 and 916 may reside on a non-transitory storage medium local to (and/or resident in) server 912. In at least one embodiment, databases 914 and 916 may be remote from server 912 and in communication with server 912 via a network-based or dedicated connection. In at least one embodiment, databases 914 and 916 may reside in a storage-area network (SAN). In at least one embodiment, any necessary files for performing functions attributed to server 912 may be stored locally on server 912 and/or remotely, as appropriate. In at least one embodiment, databases 914 and 916 may include relational databases, such as databases that are adapted to store, update, and retrieve data in response to SQL-formatted commands.

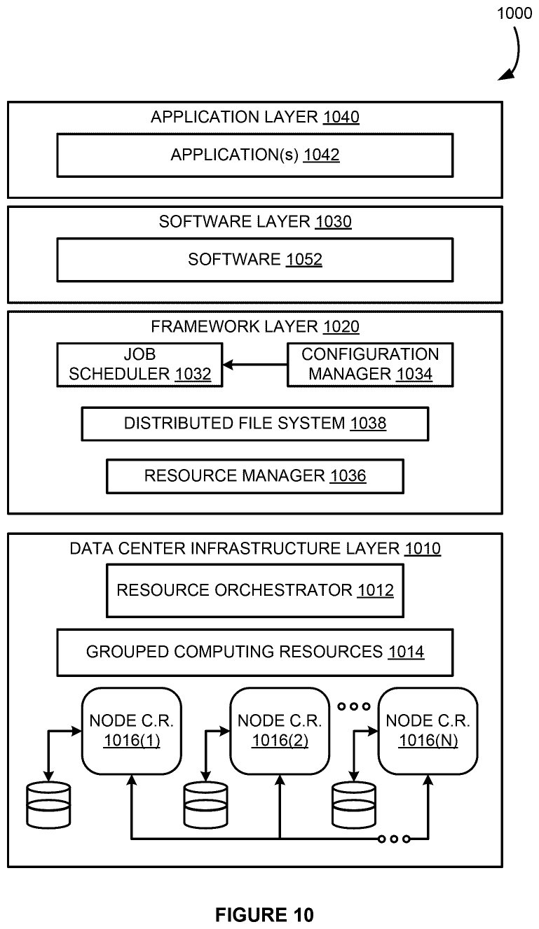

FIG. 10 illustrates a datacenter 1000, in accordance with at least at least one embodiment. In at least one embodiment, datacenter 1000 includes, without limitation, a datacenter infrastructure layer 1010, a framework layer 1020, a software layer 1030 and an application layer 1040.

In at least one embodiment, datacenter infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in datacenters at various geographical locations (also not shown). Separate groupings of node C.R.s within grouped computing resources 1014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1012 may configure or otherwise control one or more node C.R.s 1016(1)-1016(N) and/or grouped computing resources 1014. In at least one embodiment, resource orchestrator 1012 may include a software design infrastructure (“SDI”) management entity for datacenter 1000. In at least one embodiment, resource orchestrator 1012 may include hardware, software or some combination thereof.

In at least one embodiment, framework layer 1020 includes, without limitation, a job scheduler 1032, a configuration manager 1034, a resource manager 1036 and a distributed file system 1038. In at least one embodiment, framework layer 1020 may include a framework to support software 1052 of software layer 1030 and/or one or more application(s) 1042 of application layer 1040. In at least one embodiment, software 1052 or application(s) 1042 may respectively include web-based service software or applications, such as those provided by a cloud service provider. In at least one embodiment, framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of datacenter 1000. In at least one embodiment, configuration manager 1034 may be capable of configuring different layers such as software layer 1030 and framework layer 1020, including Spark and distributed file system 1038 for supporting large-scale data processing. In at least one embodiment, resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at datacenter infrastructure layer 1010. In at least one embodiment, resource manager 1036 may coordinate with resource orchestrator 1012 to manage these mapped or allocated computing resources.

In at least one embodiment, software 1052 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. In at least one or more types of applications may include, without limitation, CUDA applications, 5G network applications, artificial intelligence application, datacenter applications, and/or variations thereof.

In at least one embodiment, any of configuration manager 1034, resource manager 1036, and resource orchestrator 1012 may implement any number and type of self-modifying actions based on any amount and type of data acquired in any technically feasible fashion. In at least one embodiment, self-modifying actions may relieve a datacenter operator of datacenter 1000 from making possibly bad configuration decisions and possibly avoiding underutilized and/or poor performing portions of a datacenter.

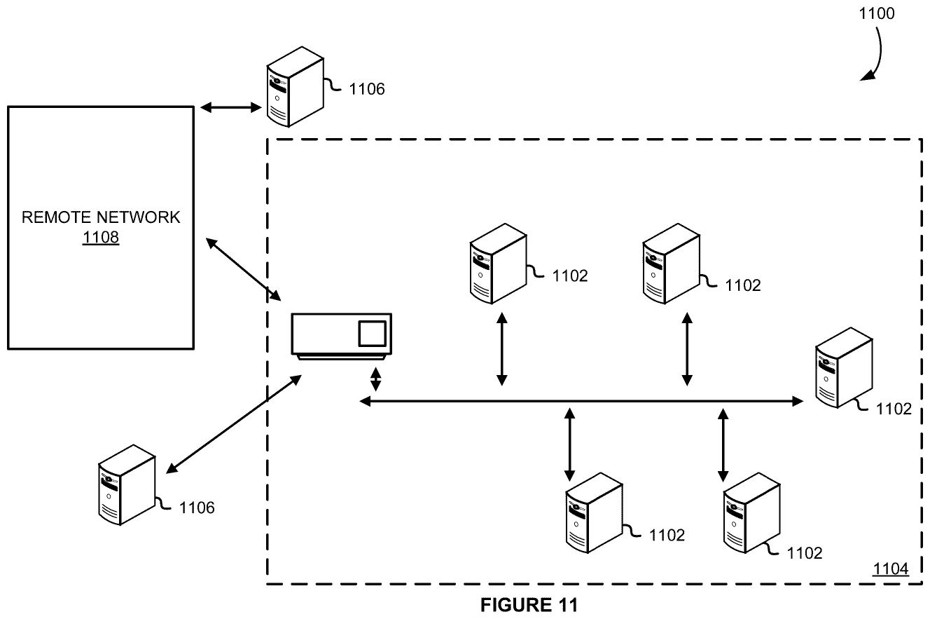

FIG. 11 illustrates a computing device 1100 including client-server network 1104 formed by a plurality of network server computers 1102 which are interlinked, in accordance with at least one embodiment. In at least one embodiment, each network server computer 1102 stores data accessible to other network server computers 1102 and to client computers 1106 and networks 1108 which link into a wide area network 1104. In at least one embodiment, configuration of a client-server network 1104 may change over time as client computers 1106 and one or more networks 1108 connect and disconnect from a network 1104, and as one or more trunk line network server computers 1102 are added or removed from a network 1104. In at least one embodiment, when a client computer 1106 and a network 1108 are connected with network server computers 1102, client-server network includes such client computer 1106 and network 1108. In at least one embodiment, the term computer includes any device or machine capable of accepting data, applying prescribed processes to data, and supplying results of processes.

In at least one embodiment, client-server network 1104 stores information which is accessible to network server computers 1102, remote networks 1108 and client computers 1106.

In at least one embodiment, network server computers 1102 are formed by main frame computers minicomputers, and/or microcomputers having one or more processors each. In at least one embodiment, network server computers 1102 are linked together by wired and/or wireless transfer media, such as conductive wire, fiber optic cable, and/or microwave transmission media, satellite transmission media or other conductive, optic or electromagnetic wave transmission media. In at least one embodiment, client computers 1106 access a network server computer 1102 by a similar wired or a wireless transfer medium. In at least one embodiment, a client computer 1106 may link into a client-server network 1104 using a modem and a standard telephone communication network. In at least one embodiment, alternative carrier systems such as cable and satellite communication systems also may be used to link into client-server network 1104. In at least one embodiment, other private or time-shared carrier systems may be used. In at least one embodiment, network 1104 is a global information network, such as the Internet. In at least one embodiment, network is a private intranet using similar protocols as the Internet, but with added security measures and restricted access controls. In at least one embodiment, network 1104 is a private, or semi-private network using proprietary communication protocols.

In at least one embodiment, client computer 1106 is any end user computer, and may also be a mainframe computer, mini-computer or microcomputer having one or more microprocessors. In at least one embodiment, network server computer 1102 may at times function as a client computer accessing another server computer 1102. In at least one embodiment, remote network 1108 may be a local area network, a network added into a wide area network through an independent service provider (ISP) for the Internet, or another group of computers interconnected by wired or wireless transfer media having a configuration which is either fixed or changing over time. In at least one embodiment, client computers 1106 may link into and access a network 1104 independently or through a remote network 1108.

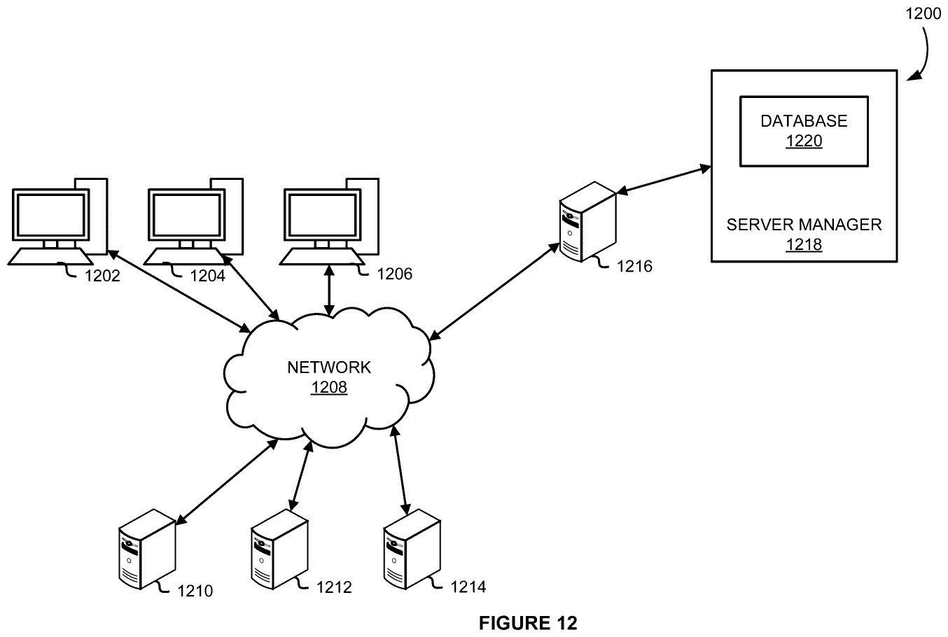

FIG. 12 illustrates a computer network 1200 connecting one or more computing machines, in accordance with at least at least one embodiment. In at least one embodiment, network 1208 may be any type of electronically connected group of computers including, for instance, the following networks: Internet, Intranet, Local Area Networks (LAN), Wide Area Networks (WAN) or an interconnected combination of these network types. In at least one embodiment, connectivity within a network 1208 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 1208 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 1208 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (e.g. www.site.com) which maps to an IP address of a network server.

In at least one embodiment, a plurality of clients 1202, 1204, and 1206 are connected to network 1208 via respective communication links. In at least one embodiment, each of these clients may access network 1208 via any desired form of communication, such as via a dial-up modem connection, cable link, a digital subscriber line (DSL), wireless or satellite link, or any other form of communication. In at least one embodiment, each client may communicate using any machine that is compatible with network 1208, such as a personal computer (PC), workstation, dedicated terminal, personal data assistant (PDA), or other similar equipment. In at least one embodiment, clients 1202, 1204, and 1206 may or may not be located in a same geographical area.

In at least one embodiment, a plurality of servers 1210, 1212, and 1214 are connected to a network 1208 to serve clients that are in communication with a network 1208. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 1210, 1212, 1214 run application programs that respond to client commands. In at least one embodiment, server 1210 may run a web server application for responding to client requests for HTML pages and may also run a mail server application for receiving and routing electronic mail. In at least one embodiment, other application programs, such as an FTP server or a media server for streaming audio/video data to clients may also be running on a server 1210. In at least one embodiment, different servers may be dedicated to performing different tasks. In at least one embodiment, server 1210 may be a dedicated web server that manages resources relating to web sites for various users, whereas a server 1212 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 1210, 1212, 1214 are under control of a web hosting provider in a business of maintaining and delivering third party content over a network 1208.

In at least one embodiment, web hosting providers deliver services to two different types of clients. In at least one embodiment, one type, which may be referred to as a browser, requests content from servers 1210, 1212, 1214 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 1216 is in communication with a network 1208 via a communication link. In at least one embodiment, intranet server 1216 is in communication with a server manager 1218. In at least one embodiment, server manager 1218 comprises a database of an application program configuration parameters which are being utilized in servers 1210, 1212, 1214. In at least one embodiment, users modify a database 1220 via an intranet server 1216, and a server manager 1218 interacts with servers 1210, 1212, 1214 to modify application program parameters so that they match a content of a database. In at least one embodiment, a user logs onto an intranet server 1216 by connecting to an intranet server 1216 via client 1202 and entering authentication information, such as a username and password.

In at least one embodiment, when a user wishes to sign up for new service or modify an existing service, an intranet server 1216 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 1216 updates a database 1220. In at least one embodiment, server manager 1218 forwards this information to an appropriate server, and a new parameter is used during application program operation. In at least one embodiment, an intranet server 1216 is configured to provide users with access to configuration parameters of hosted network resources (e.g., web pages, email, FTP sites, media sites, etc.), for which a user has contracted with a web hosting service provider.

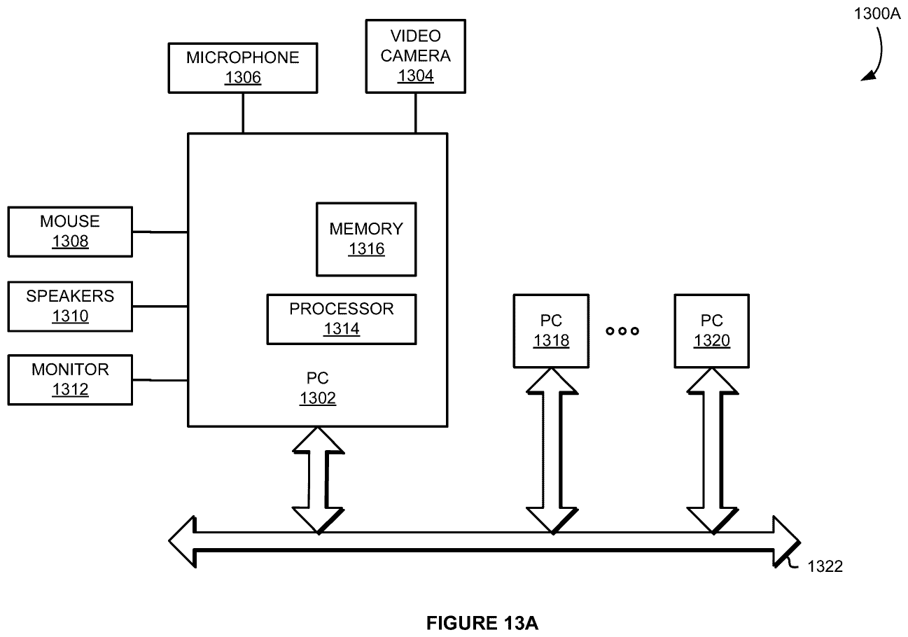

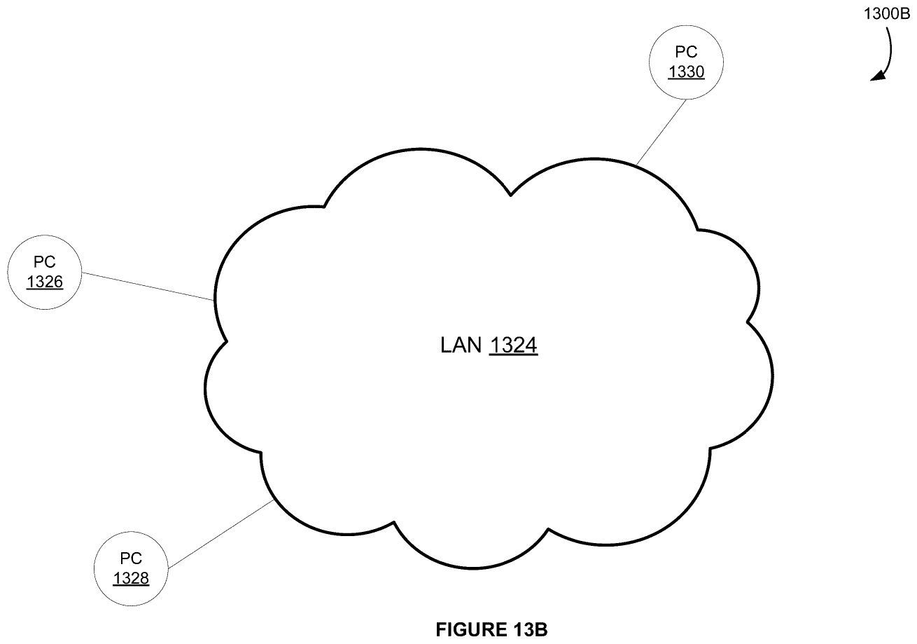

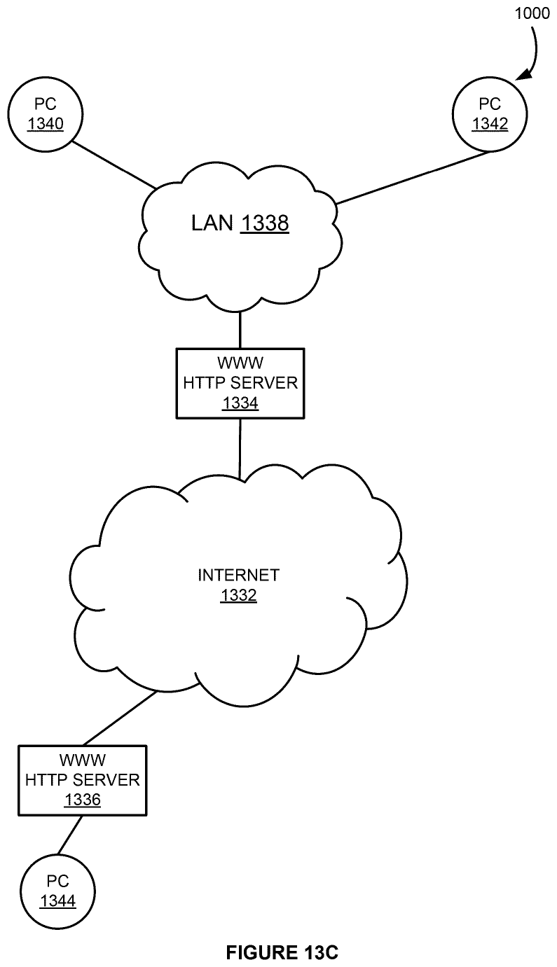

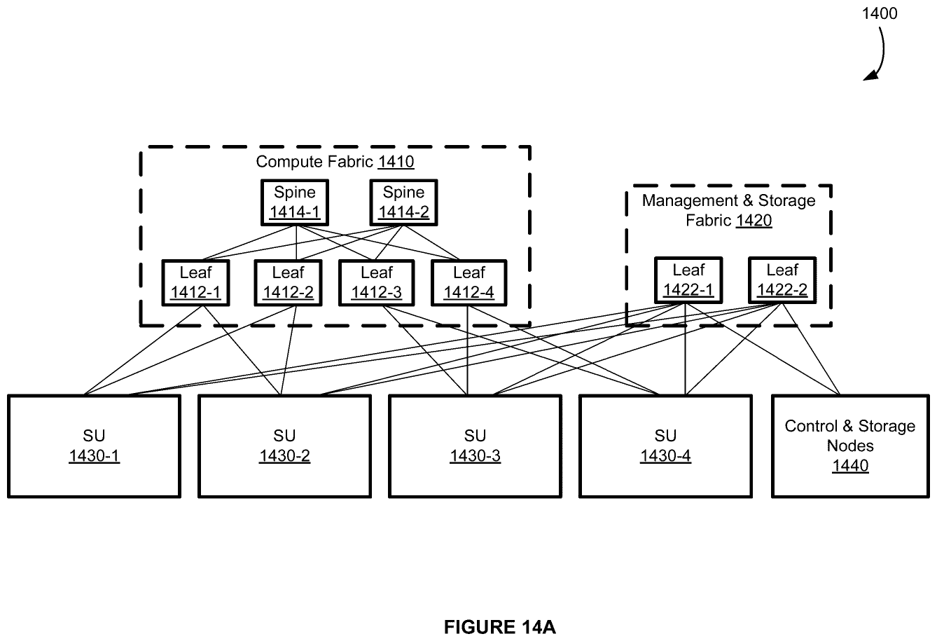

FIG. 13A illustrates a networked computer system 1300A, in accordance with at least at least one embodiment. In at least one embodiment, networked computer system 1300A comprises a plurality of nodes or personal computers (“PCs”) 1302, 1318, 1320. In at least one embodiment, personal computer or node 1302 comprises a processor 1314, memory 1316, video camera 1304, microphone 1306, mouse 1308, speakers 1310, and monitor 1312. In at least one embodiment, nodes 1302, 1318, 1320 may each run one or more desktop servers of an internal network within a given company, for instance, or may be servers of a general network not limited to a specific environment. In at least one embodiment, there is one server per node of a network, so that each node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 1302, 1318, 1320 and other nodes of a network are interconnected via medium 1322. In at least one embodiment, medium 1322 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of an URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 1314 is a general-purpose programmable processor. In at least one embodiment, processors of nodes of networked computer system 1300A may also be special-purpose video processors. In at least one embodiment, various peripherals and components of a node such as those of node 1302 may vary from those of other nodes. In at least one embodiment, node 1318 and node 1320 may be configured identically to or differently than node 1302. In at least one embodiment, a node may be implemented on any suitable computer system in addition to PC systems.

FIG. 13B illustrates a networked computer system 1300B, in accordance with at least at least one embodiment. In at least one embodiment, the networked computer system 1300B illustrates a network such as LAN 1324, which may be used to interconnect a variety of nodes that may communicate with each other. In at least one embodiment, attached to LAN 1324 are a plurality of nodes such as PC nodes 1326, 1328, 1330. In at least one embodiment, a node may also be connected to the LAN via a network server or other means. In at least one embodiment, the networked computer system 1300B comprises other types of nodes or elements, for example including routers, servers, and nodes.

FIG. 13C illustrates a networked computer system 1300C, in accordance with at least at least one embodiment. In at least one embodiment, the networked computer system 1300C illustrates a WWW system having communications across a backbone communications network such as Internet 1332, which may be used to interconnect a variety of nodes of a network. In at least one embodiment, WWW is a set of protocols operating on top of the Internet, and allows a graphical interface system to operate thereon for accessing information through the Internet. In at least one embodiment, attached to Internet 1332 in WWW are a plurality of nodes such as PCs 1140, 1342, 1344. In at least one embodiment, a node is interfaced to other nodes of WWW through a WWW HTTP server such as servers 1334, 1336. In at least one embodiment, PC 1344 may be a PC forming a node of Internet 1332 and itself running its server 1336, although PC 1344 and server 1336 are illustrated separately in FIG. 13C for illustrative purposes.

In at least one embodiment, WWW is a distributed type of application, characterized by WWW HTTP, WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 1338 as illustrated with respect to WWW HTTP server 1334. In at least one embodiment, the networked computer system 1300C may also comprise other types of nodes or elements. In at least one embodiment, a WWW HTTP server is an application running on a machine, such as a PC. In at least one embodiment, each user may be considered to have a unique “server,” as illustrated with respect to PC 1344. In at least one embodiment, a server may be considered to be a server such as WWW HTTP server 1334, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

The data center architecture can include an accelerated ethernet platform that can boost network performance by up to 1.6× compared to traditional networks. This translates to faster AI training, inference, and overall application execution. The data center architecture is designed to provide the levels of computing performance required to solve advanced computational challenges in mainstream AI and multi-workload end-to-end generative AI applications where graphics and AI are required in the end-to-end pipeline for best user experience.

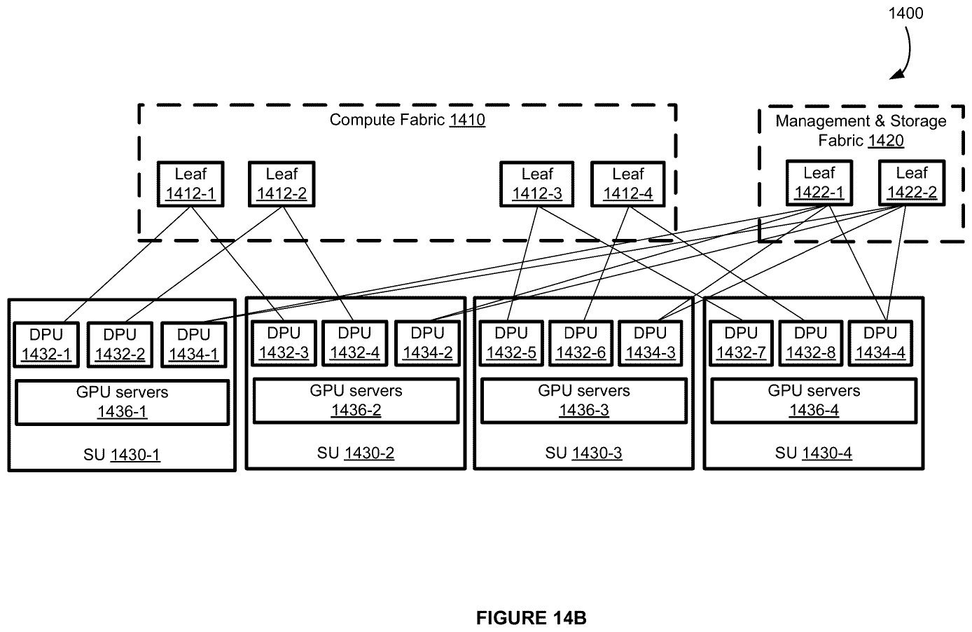

FIGS. 14A-14B depict a data center architecture (“architecture”) 1400, in accordance with at least one embodiment. The architecture 1400 can represent a cluster include servers and corresponding graphics processing units (GPUs). For example, the architecture 1400 can represent the OVX L40S GPU Cluster provided by NVIDIA®. The cluster can include 128 servers totaling 512 GPUs by default. However, the architecture 1400 is scalable, and can be expanded up to 2048 GPUs with minimal impact on performance scaling. The architecture 1400 is organized into 16 server racks (e.g., OVX L40S GPU server racks), one leaf & spine switch rack, and two management & storage racks. Each server rack can contain 8 compute server nodes, with each node equipped with 4 L40S GPUs, providing high-density GPU resources per rack. The cluster configuration can include 12 control server nodes and 12 storage server nodes, ensuring robust management and data handling capabilities. The default rack layout, featuring a single leaf & spine switch rack, assumes the presence of power supply redundancy within each rack. Otherwise, an alternative rack layout can be considered to maintain system reliability. The number of servers per rack can be determined by the available rack power, ensuring safe and efficient operation. Each server can be provisioned with a single-node bandwidth of 2×200 Gbps, and the network is designed to be flexible and scalable to accommodate increasing capacity and bandwidth requirements.

For example, the architecture 1400 can include servers interconnected via a compute fabric 1410 (e.g., Spectrum-X 400G compute fabric). The compute fabric 1410 implements a leaf-spine network topology designed for high performance, utilizing rail-optimized, non-blocking 128-port leaf switches 1412-1 through 1412-4, and spine switches 1414-1 and 1414-2. The leaf switches 1412-1 through 1412-4 provide 64 downlinks and 64 uplinks to scalable units (SUs) 1430-1 through 1430-4, where each SU can include 4 racks and 32 GPU nodes. The spine switches 1414-1 and 1414-2 are the core backbone switches connecting the leaf switches 1412-1 through 1412-4. The leaf switches 1412-1 through 1412-4 provide aggregate connections from GPU nodes to the spin switches 1414-1 and 1414-2. This architecture supports high throughput and low-latency communication between nodes. The compute fabric 1410 can employ a full non-blocking fat tree topology, which is optimal for high-performance applications, and is based on a RDMA (Remote Direct Memory Access) technology to minimize latency and maximize bandwidth.

The leaf-spine network topology implemented by the compute fabric 1410, in conjunction with rail-optimized Data Processing Units (DPUs), which can implement SmartNICs to provide hardware acceleration for network and storage functions, can be designed to provide the shortest and most efficient network paths for GPU-to-GPU communication, both within individual nodes and across multiple nodes. This architecture is highly effective for multi-GPU workloads and supports both top-of-rack (ToR) and end-of-row (EoR) switch configurations, enabling flexible deployment options to accommodate a variety of data center layouts. The compute fabric 1410 delivers a scalable and robust network infrastructure, capable of supporting clusters ranging from small to very large sizes, while maintaining predictable and consistent performance. The compute fabric 1410 can be engineered to maximize aggregate bandwidth and minimize network latency for GPU interconnects, both within a server and across rails, by leveraging high-speed, low-latency switching and optimized routing algorithms.

As another example, for management and storage, the architecture 1412 can include a management & storage fabric 1420 (e.g., a 200G Ethernet in-band management & storage fabric). The management & storage fabric 1420 can support High Availability (HA) by utilizing two 128-port leaf switches 1422-1 and 1422-2. All nodes are redundantly connected to both leaf switches 1422-1 and 1422-2, ensuring uninterrupted operation in the event of a switch failure. The management & storage fabric 1420 is architecturally independent from the compute fabric 1410, which allows for the optimization of both storage and application performance. For example, in addition to connections to the SUs 1430-1 through 1430-4, the leaf switches 1422-1 and 1422-2 can be connected to control and storage nodes 1440. In a typical configuration, there may be 12 control nodes and 12 storage nodes. Cluster provisioning and orchestration can be managed by the Base Command Manager (BCM), which is responsible for provisioning all server nodes and network devices. The BCM supports automated deployment of Kubernetes or SLURM (Simple Linux Utility for Resource Management) clusters, enabling dynamic resource management, workload scheduling, and rapid scaling of cluster resources.

For example, as illustrated in FIG. 14B, SU 1430-1 can include DPUs 1432-1 and 1432-2 for its GPU network, DPU 1434-1 for its CPU network, and GPU servers 1436-1. SU 1430-2 can include DPUs 1432-3 and 1432-4 for its GPU network, DPU 1434-2 for its CPU network, and GPU servers 1436-2. SU 1430-3 can include DPUs 1432-5 and 1432-6 for its GPU network, DPU 1434-3 for its CPU network, and GPU servers 1436-3. SU 1430-4 can include DPUs 1432-7 and 1432-8 for its GPU network, DPU 1434-4 for its CPU network, and GPU servers 1436-4. Each DPU can implement a SmartNIC, providing hardware acceleration for network and storage functions. With respect to compute fabric 1410, leaf switch 1412-1 can be connected to DPUs 1432-1 and 1432-3, leaf switch 1412-2 to DPUs 1432-2 and 1432-4, leaf switch 1412-3 to DPUs 1432-5 and 1432-7, and leaf switch 1412-4 to DPUs 1432-6 and 1432-8.

For the management & storage fabric 1420, leaf switches 1422-1 and 1422-2 can each be connected to DPUs 1434-1 through 1434-4. Although not depicted in FIG. 14B, each of the SUs 1430-1 through 1430-4 can include a respective Intelligent Platform Management Interface (IPMI), and each of the leaf switches 1422-1 and 1422-2 can be connected to each of the IPMIs. Although not depicted in FIGS. 14A-B, the control & storage nodes 1440 can include a storage node, a control node and an IPMI, and each of the leaf switches 1422-1 and 1422-2 can be connected to the storage node, the control node and the IPMI.

For inference workloads, an East/West (E/W) network is typically not required, as most pre-trained models can be accommodated within the memory of a single GPU. However, models that exceed approximately 13B parameters may require model parallelism and the use of multiple GPUs, in which case E/W network connectivity may become necessary. For typical inference use cases, the E/W network can be omitted, simplifying the network design and reducing cost and complexity. It is important to note that while tensor parallelism enables the distribution of large models across multiple GPUs, it can result in lower performance compared to running models entirely on a single GPU due to increased communication overhead. Supported model sizes for optimal performance are generally up to 13B parameters, although larger models may be supported with appropriate parallelization strategies and network design.

Inference and prediction tasks within the cluster are highly dynamic, often requiring auto-scaling of compute engines and inference server instances. Fine-tuning can be used to optimize which models are loaded on which inference servers, ensuring efficient resource utilization and rapid response to changing workload demands. Additional technical considerations may include monitoring GPU utilization, managing model versioning, and implementing load balancing strategies to further enhance inference performance and reliability.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a memory; and
at least one processing device, operatively coupled with the memory, to:
receive input data indicative of an original quantum state of a quantum system that is modified by an amount of noise added by a non-unitary quantum channel;
provide the input data to a machine learning model trained to predict the original quantum state in order to perform error mitigation by simulating an inverse of the non-unitary quantum channel; and
obtain, from the machine learning model, output data indicative of the original quantum state.

2. The system of claim 1, wherein the machine learning model is a diffusion model.

3. The system of claim 2, wherein the machine learning model comprises a recurrent neural network, wherein the machine learning model is trained by simulating one or more non-unitary quantum channels, comprising the non-unitary quantum channel, based on one or more sequences of weak measurements of one or more quantum states, and wherein each sequence of weak measurements of a quantum state comprises multiple weak measurements of the quantum state, captured in a temporal order, that do not fully collapse a wave function corresponding to the quantum state.

4. The system of claim 2, wherein the machine learning model is trained to perform a reverse diffusion process to predict a backward evolution of noise added to the original quantum state in accordance with a forward diffusion process.

5. The system of claim 4, wherein the forward diffusion process comprises one or more iterations, and wherein each iteration of the one or more iterations of the forward diffusion process is performed by:
initializing a first quantum state represented by a first density matrix associated with a Hilbert space;
determining, based on the density matrix, whether a purity of the first quantum state satisfies a threshold condition defined based on a maximally mixed quantum state for the Hilbert space; and
in response to determining that the purity of the first quantum state satisfies the threshold condition, modifying the first density matrix to obtain a second density matrix representing a second quantum state.

6. The system of claim 1, wherein the at least one processing device is further configured to perform at least one quantum computing action using the output data.

7. The system of claim 6, wherein the at least one quantum computing action comprises sending, to a quantum computing system, data indicative of the original quantum state predicted by the machine learning model.

8. The system of claim 1, wherein the input data comprises a modified message corresponding to an original message modified by the amount of noise, and wherein the output data comprises a prediction of the original message.

9. The system of claim 1, wherein the machine learning model is used to identify a noise type added by the non-unitary quantum channel.

10. The system of claim 1, wherein the input data corresponds to one or more optical qubits.

11. The system of claim 1, further comprising:
a first quantum computing system; and
a second quantum computing system associated with the at least one processing device;
wherein the original quantum state is sent by the first quantum computing system to one or more quantum computing systems comprising second quantum computing system via one or more non-unitary quantum channels comprising the non-unitary quantum channel.

12. A system comprising:
a memory; and
at least one processing device, operatively coupled with the memory, to:
cause a sequence of measurements of a quantum state of a quantum system to be obtained, wherein the sequence of measurements comprises multiple measurements captured in a temporal order, and wherein each measurement of the sequence of measurements simulates a respective amount of noise added to an original quantum state by a non-unitary quantum channel at a respective time step;
generate a training dataset comprising the sequence of measurements of the quantum state; and
train, using the training dataset, a machine learning model to predict the original quantum state in order to perform error mitigation by simulating an inverse of the non-unitary quantum channel.

13. The system of claim 12, wherein each measurement of the sequence of measurements of the quantum state is a weak measurement of the quantum state that does not fully collapse a wave function corresponding to the quantum state.

14. The system of claim 12, wherein the machine learning model is a diffusion model.

15. The system of claim 14, wherein the machine learning model comprises a recurrent neural network.

16. The system of claim 14, wherein, to train the machine learning model to predict the original quantum state by simulating the inverse of the non-unitary quantum channel, the at least one processing device is to train the machine learning model to perform a reverse diffusion process to predict a backward evolution of noise added to the original quantum state in accordance with a forward diffusion process.

17. The system of claim 16, wherein:
the forward diffusion process comprises one or more iterations; and
to train the machine learning model to predict the original quantum state by simulating the inverse of the non-unitary quantum channel, the at least one processing device is further to perform each iteration of the one or more iterations of the forward diffusion process by:
initializing a first quantum state represented by a first density matrix associated with a Hilbert space;
determining, based on the density matrix, whether a purity of the first quantum state satisfies a threshold condition defined based on a maximally mixed quantum state for the Hilbert space; and
in response to determining that the purity of the first quantum state satisfies the threshold condition, modifying the first density matrix to obtain a second density matrix representing a second quantum state.

18. The system of claim 17, wherein:
determining whether the purity of the first quantum state satisfies the threshold condition comprises determining whether a trace determined from the first density matrix is greater than or equal to a threshold value defined based on a trace determined for the maximally mixed quantum state; and
modifying the first density matrix to obtain the second density matrix comprises applying a randomly selected basis measurement to the first density matrix.

19. A system comprising:
a first quantum computing system to measure an original quantum state of a quantum system; and
a second quantum computing system communicably coupled to the first quantum computing system via an interconnect, wherein the second quantum computing system is configured to:
receive, from the first quantum computing system, input data indicative of the original quantum state that is modified by an amount of noise added by a non-unitary quantum channel;
provide the input data to a machine learning model trained to predict the original quantum state in order to perform error mitigation by simulating an inverse of the non-unitary quantum channel; and
obtain, from the machine learning model, output data indicative of the original quantum state.

20. The system of claim 19, wherein the machine learning model comprises a recurrent neural network, wherein the machine learning model is trained by simulating one or more non-unitary quantum channels, comprising the non-unitary quantum channel, based on one or more sequences of weak measurements of one or more quantum states, and wherein each sequence of weak measurements of a quantum state comprises multiple weak measurements of the quantum state, captured in a temporal order, that do not fully collapse a wave function corresponding to the quantum state.

21. A method comprising:
receiving input data indicative of an original quantum state of a quantum system that is modified by an amount of noise added by a non-unitary quantum channel;
providing the input data to a machine learning model trained to predict the original quantum state in order to perform error mitigation by simulating an inverse of the non-unitary quantum channel; and
obtaining, from the machine learning model, output data indicative of the original quantum state.

22. The method of claim 21, wherein:
the machine learning model is a diffusion model, comprising a recurrent neural network, that is trained by simulating one or more non-unitary quantum channels, comprising the non-unitary quantum channel, based on one or more sequences of weak measurements of one or more quantum states that do not fully collapse one or more wave functions corresponding to the one or more quantum states; and
each sequence of measurements of a quantum state comprises multiple measurements of the quantum state captured in a temporal order.
